(19) United States
(12) Patent Application Publication
(10) Pub. No.: US 2024/0296738 A1
(43) Pub. Date: Sep. 5, 2024

(54) INFORMATION PROVISION METHOD AND PARKING LOT MANAGEMENT SYSTEM

(71) Applicant: Panasonic Automotive Systems Co., Ltd., Kanagawa (JP)

(72) Inventors: Akihiko IGUCHI, Osaka Fu (JP); Fumio KOSUGE, Kanagawa Ken (JP); Shinya AIZAWA, Kanagawa Ken (JP)

(73) Assignee: Panasonic Automotive Systems Co., Ltd., Kanagawa (JP)

(21) Appl. No.: 18/664,805

(22) Filed: May 15, 2024

Related U.S. Application Data
(63) Continuation of application No. PCT/JP2022/029840, filed on Aug. 3, 2022.

(30) Foreign Application Priority Data
Dec. 6, 2021 (JP) 2021-197637

(51) Int. Cl. G08G 1/14; B60W 30/06; B60W 60/00

(52) U.S. Cl. CPC G08G 1/144; B60W 30/06; B60W 60/001; G08G 1/143; G08G 1/148

(57) ABSTRACT

An information provision method includes: acquiring request information inquiring about a substitute parking lot of a first parking lot from an information terminal of a user; acquiring vacancy information indicating availability of a second parking lot when the request information is acquired, from a second parking lot management system that manages availability of the second parking lot managed by a second operator different from a first operator of the use facility and existing outside an area of the use facility; generating map information indicating the second parking lot having a vacancy; and transmitting the map information to the information terminal to display the map information on the information terminal. The map information includes a message indicating that second incentive for encouraging the user to use the second parking lot is larger than first incentive for encouraging the user to use the first parking lot of the use facility.

### CROSS-REFERENCE TO RELATED APPLICATIONS

This application is a continuation of International Application No. PCT/JP2022/029840, filed on Aug. 3, 2022 which claims the benefit of priority of the prior Japanese Patent Application No. 2021-197637, filed on Dec. 6, 2021, the entire contents of which are incorporated herein by reference.

### FIELD

Embodiments described herein relate generally to an information provision method and a parking lot management system.

### BACKGROUND

A use facility such as a commercial facility often has a parking lot for the use facility. However, at the time of congestion, there is a case where congestion occurs to such an extent that a traffic jam occurs on a road to the parking lot for the use facility. Parking lots operated by operating operators different from an operating operator of the use facility may be scattered around the use facility, but the parking lots are not affiliated with the use facility. This is because there is no platform with which the use facility easily affiliates with the operating operators of the parking lots around the use facility. For example, a user has no means to know which parking lot is affiliated with the use facility.

As a system that enables alternative use of a parking lot among a plurality of parking lots, for example, systems of JP 2000-215333 A and JP 2020-80102 A are disclosed.

However, in the conventional art, it is necessary to newly install an exchange machine for sharing parking lots, and a parking lot that can be used as an alternative is not provided to a user in an easy-to-understand manner, and there is a case where a traffic jam in the vicinity of the use facility during congestion is not alleviated.

An object to be achieved by the present disclosure is to provide an information provision method and a parking lot management system capable of alleviating a traffic jam in the vicinity of a use facility during congestion.

### SUMMARY

According to an embodiment of the present disclosure, an information provision method in a first parking lot management system, which communicates with an information terminal of a user and manages availability of a first parking lot provided in a use facility, includes: acquiring, from the information terminal of the user, request information inquiring about a substitute parking lot of the first parking lot; acquiring, from a second parking lot management system that manages availability of a second parking lot managed by a second operator different from a first operator of the use facility and existing outside an area of the use facility, vacancy information indicating availability of the second parking lot at a time point when the request information is acquired; generating map information indicating the second parking lot having a vacancy based on the vacancy information, the map information including a message indicating that a second incentive for encouraging the user to use the second parking lot is larger than a first incentive for encouraging the user to use the first parking lot of the use facility; and transmitting the map information to the information terminal to display the map information on the information terminal.

### BRIEF DESCRIPTION OF THE DRAWINGS

FIG. 1 is a schematic diagram of an example of a parking lot management system;

FIG. 2 is a functional block diagram of an example of a parking lot management system;

FIG. 3A is a schematic diagram illustrating an example of a data configuration of user data;

FIG. 3B is a schematic diagram illustrating an example of a data configuration of second parking lot management data;

FIG. 3C is a schematic diagram illustrating an example of a data configuration of incentive information;

FIG. 3D is a schematic diagram illustrating an example of a data configuration of incentive information;

FIG. 4 is a sequence diagram illustrating an example of a flow of pre-processing executed in the parking lot management system;

FIG. 5 is a sequence diagram illustrating an example of a flow of information provision processing executed in the parking lot management system;

FIG. 6A is a schematic diagram of an example of a display screen;

FIG. 6B is a schematic diagram of an example of a display screen;

FIG. 6C is a schematic diagram of an example of a display screen;

FIG. 6D is a schematic diagram of an example of a display screen;

FIG. 7 is a flowchart illustrating an example of a flow of information processing executed in a first parking lot management server;

FIG. 8 is a schematic diagram of an example of a cooperative configuration of a car navigation system of a vehicle, an information terminal, and a first parking lot management server;

FIG. 9 is a sequence diagram illustrating an example of a flow of information provision processing in cooperation with a car navigation system of a vehicle;

FIG. 10A is a flowchart of an example of a flow of information processing executed in an information terminal;

FIG. 10B is a flowchart of an example of a flow of information processing after reception of parking ticket information executed in an information terminal;

FIG. 11 is a schematic diagram of an example of a cooperative configuration of an automated driving ECU of a vehicle, an information terminal, and a first parking lot management server;

FIG. 12 is a sequence diagram illustrating an example of a flow of information provision processing in cooperation with an automated driving ECU of a vehicle;

FIG. 13 is a flowchart of an example of a flow of information processing executed in an information terminal; and

FIG. 14 is a block diagram illustrating a hardware configuration example.

### DETAILED DESCRIPTION

Hereinafter, embodiments of an information provision method and a parking lot management system according to the present disclosure will be described with reference to the accompanying drawings.

### First Embodiment

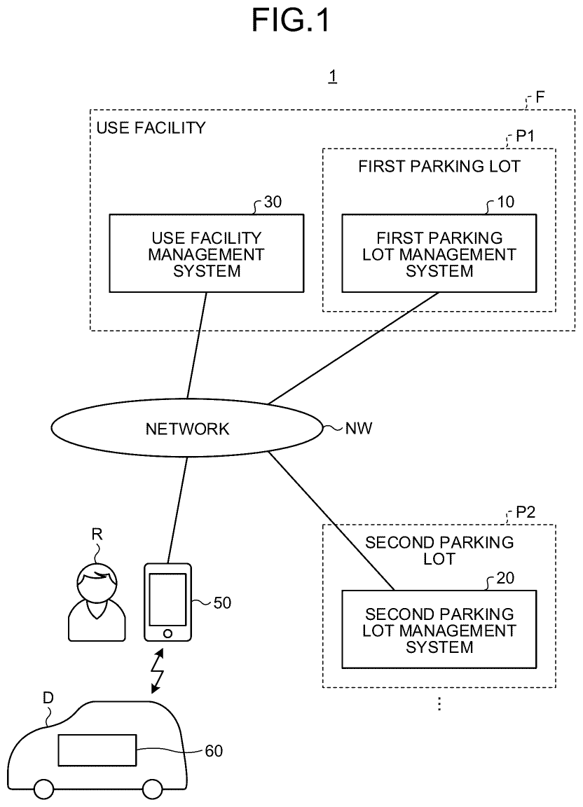

FIG. 1 is a schematic diagram of an example of a parking lot management system 1 of the present embodiment.

The parking lot management system 1 is a system that manages a first parking lot P1 and a second parking lot P2.

The first parking lot P1 is a parking lot owned by a use facility F. The first parking lot P1 is managed by a first operator that is an operating operator of the use facility F. The first parking lot P1 exists, for example, in an area of the use facility F.

The use facility F is a facility used by a user R. The use facility F is, for example, a commercial facility, a medical facility, or the like. In the present embodiment, a case where the use facility F is a commercial facility will be described as an example.

The second parking lot P2 is a parking lot existing outside the area of the use facility F. The second parking lot P2 is managed by a second operator that is different from the first operator of the use facility F. The second operator is an operating operator of the second parking lot P2. The second parking lot P2 functions as an extended parking lot of the first parking lot P1 by registration application to be described below.

The parking lot management system 1 includes a first parking lot management system 10, a second parking lot management system 20, a use facility management system 30, an information terminal 50, and an in-vehicle system 60 mounted on a vehicle D.

The first parking lot management system 10, the second parking lot management system 20, the use facility management system 30, the information terminal 50, and the in-vehicle system 60 are communicably connected via a network NW or the like. Note that the information terminal 50 and the in-vehicle system 60 may communicate with each other by short-range wireless communication such as Bluetooth (registered trademark). In the present embodiment, a mode in which the information terminal 50 and the in-vehicle system 60 communicate with each other by Bluetooth will be described as an example.

The first parking lot management system 10 is a system that communicates with the information terminal 50 of the user R and manages the availability of the first parking lot P1 provided in the use facility F. The second parking lot management system 20 is a system that manages the availability of the second parking lot P2. The use facility management system 30 is a system that manages the use facility F. The information terminal 50 is an information processing device managed by the user R. The in-vehicle system 60 is various systems provided in the vehicle D. Details of these systems and terminals will be described below.

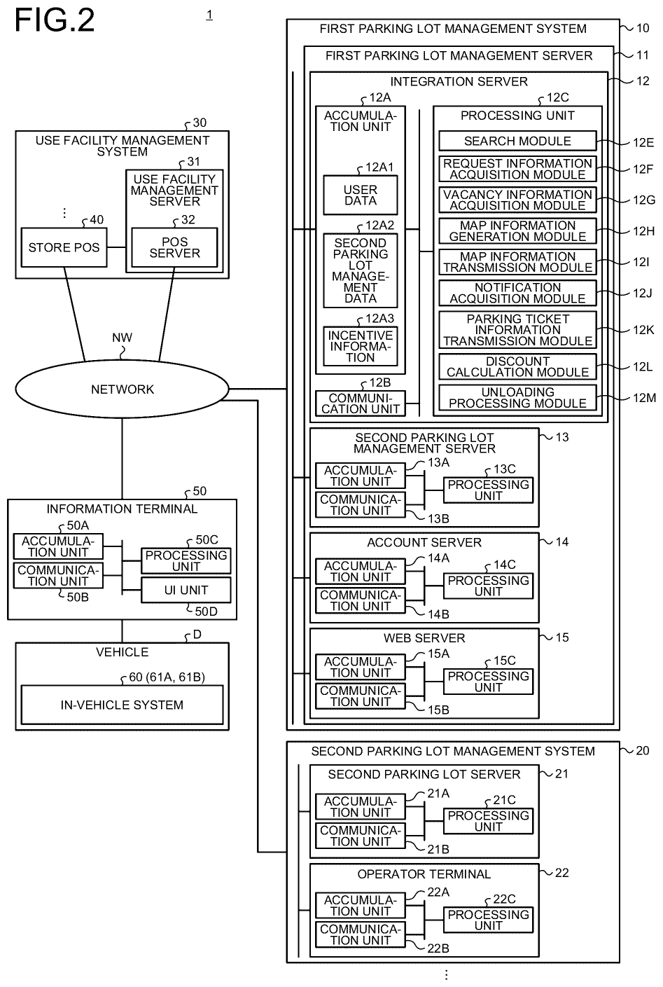

FIG. 2 is a functional block diagram of an example of the parking lot management system 1.

The first parking lot management system 10 includes a first parking lot management server 11. The first parking lot management server 11 is an example of an information processing device that manages the availability of the first parking lot P1 provided in the use facility F. In the present embodiment, the first parking lot management server 11 includes an integration server 12, a second parking lot management server 13, an account server 14, and a WEB server 15. The integration server 12, the second parking lot management server 13, the account server 14, and the WEB server 15 are communicably connected.

The integration server 12 is an information processing device that integrates and manages the plurality of servers included in the first parking lot management server 11.

The integration server 12 includes an accumulation unit 12A, a communication unit 12B, and a processing unit 12C. The accumulation unit 12A, the communication unit 12B, and the processing unit 12C are communicably connected.

The accumulation unit 12A accumulates various types of information. The accumulation unit 12A accumulates, for example, information such as user data 12A1, second parking lot management data 12A2, and incentive information 12A3.

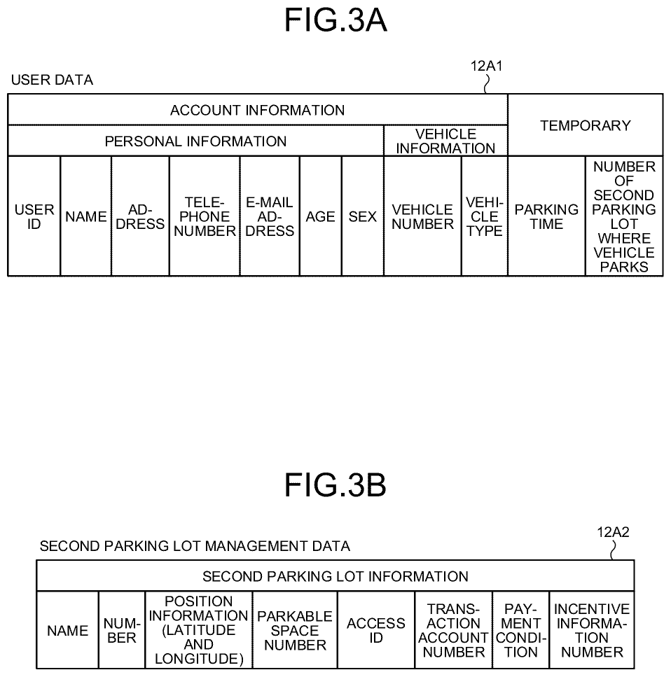

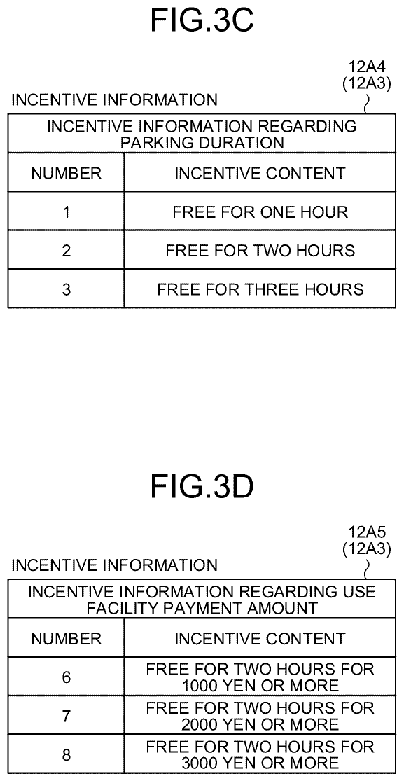

FIG. 3A is a schematic diagram illustrating an example of a data configuration of the user data 12A1. The user data 12A1 is a database that accumulates information regarding the user R who uses the parking lot management system 1. A data format of the user data 12A1 may be a table or the like, and is not limited to a database.

The user data 12A1 accumulates account information and temporary in association with each other. The account information includes personal information of the user R and vehicle information of the vehicle D managed by the user R.

The personal information includes, for example, a user ID, a name, an address, a telephone number, an e-mail address, an age, a sex, and the like. The user ID is identification information of the user R.

The vehicle information is information regarding the vehicle D. The vehicle information includes, for example, information indicating a vehicle number of the vehicle D, a vehicle type of the vehicle D, and the like.

The vehicle D specified by the vehicle information registered in association with the personal information of the user R in the user data 12A1 is, for example, a vehicle owned by the user R. Note that it is sufficient if the vehicle D is a vehicle that is temporarily, intermittently, or long-term managed by the user R, and the vehicle D is not limited to the vehicle owned by the user R. For example, the vehicle D may be a vehicle in which the user R can ride on a seat other than the driver's seat, a vehicle that is temporarily or intermittently used using a rental car, car sharing, or the like.

The temporary is information temporarily associated and accumulated with the user R specified by the corresponding account information. For example, information indicating the parking time when the vehicle D of the user R specified by the corresponding account information is parked in the second parking lot P2, the number of the second parking lot P2 where the vehicle D is parked, and the like is accumulated in the temporary.

FIG. 3B is a schematic diagram illustrating an example of a data configuration of the second parking lot management data 12A2. The second parking lot management data 12A2 is a database that accumulates second parking lot information of the second parking lot P2. A data format of the second parking lot management data 12A2 may be a table or the like, and is not limited to a database.

In the second parking lot management data 12A2, the second parking lot information is registered for each second parking lot P2. In the present embodiment, a mode in which the second parking lot information of each of a plurality of second parking lots P2 is registered in the second parking lot management data 12A2 will be described as an example.

The second parking lot information includes a name of the second parking lot P2, the number of the second parking lot P2, position information of the second parking lot P2, a parkable space number of the second parking lot P2, an access ID of a second parking lot server 21, a transaction account number, a payment condition, and an incentive information number.

The number of the second parking lot P2 is identification information of the second parking lot P2. The position information of the second parking lot P2 is information indicating the position of the second parking lot P2 in real space. The position information of the second parking lot P2 includes, for example, information indicating the latitude and longitude of the position of the second parking lot P2.

The parkable space number of the second parking lot P2 is the number of a space in an empty state where the vehicle D can be parked in the second parking lot P2. Note that it is sufficient if vacancy information indicating the availability of the second parking lot P2 is registered in the second parking lot management data 12A2. Therefore, in the second parking lot management data 12A2, proportion information indicating a vacant state of the second parking lot P2 and the like may be registered together with the parkable space number. In the present embodiment, a case where the vacancy information indicating the availability of the second parking lot P2 is the parkable space number of the second parking lot P2 will be described as an example.

The transaction account number is the number of a transaction account of the second operator used at the time of distribution of parking fees to the second operator. The payment condition is information indicating a condition regarding payment such as a distribution ratio of parking fees.

The incentive information number is information for uniquely identifying a type of incentive information to be described below. The incentive information is information regarding a parking fee discount.

The name of the second parking lot P2, the position information of the second parking lot P2, the number of the second parking lot P2, the access ID of the second parking lot server 21, the transaction account number, the payment condition, and the incentive information number included in the second parking lot information registered in the second parking lot management data 12A2 are determined by a contract or the like between the first operator and the second operator, and are registered by processing by the processing unit 12C to be described below (details will be described below).

As the parkable space number included in the second parking lot information registered in the second parking lot management data 12A2, the number of the parkable space in the second parking lot P2 is registered by processing by the processing unit 12C to be described below, and is appropriately updated to the latest number of the parkable space according to the availability of the second parking lot P2.

FIGS. 3C and 3D are schematic diagrams illustrating an example of a data configuration of the incentive information 12A3. The incentive information 12A3 is a database in which the incentive information number and the incentive content are accumulated in association with each other. A data format of the incentive information 12A3 may be a table or the like, and is not limited to a database.

In the present embodiment, a mode in which two types of incentive information 12A3 are registered in advance in the accumulation unit 12A will be described as an example. Note that one type or three or more types of incentive information 12A3 may be registered in advance in the accumulation unit 12A.

In the present embodiment, a mode in which two types of incentive information 12A3: incentive information 12A4 regarding parking duration and incentive information 12A5 regarding a use facility payment amount are registered in the accumulation unit 12A will be described as an example.

The incentive information 12A4 regarding the parking duration is a database in which incentive information regarding the parking duration is registered, and has a configuration in which the incentive information number and the incentive content are associated with each other.

The incentive information 12A5 regarding the use facility payment amount is a database in which incentive information regarding the use facility payment amount is registered, and has a configuration in which the incentive information number and the incentive content are associated with each other.

Returning to FIG. 2, the description will be continued. The communication unit 12B transmits and receives information to and from another information processing device. The processing unit 12C executes various types of information processing. Details of the processing unit 12C of the integration server 12 will be described below.

Next, the second parking lot management server 13 will be described. The second parking lot management server 13 is an information processing device for managing the position information of the second parking lot P2 and the availability of the second parking lot P2.

The second parking lot management server 13 includes an accumulation unit 13A, a communication unit 13B, and a processing unit 13C. The accumulation unit 13A, the communication unit 13B, and the processing unit 13C are communicably connected.

The accumulation unit 13A accumulates various types of information. The communication unit 13B transmits and receives information to and from another information processing device. The processing unit 13C executes various types of information processing.

In the present embodiment, the processing unit 13C of the second parking lot management server 13 performs the registration processing of the second parking lot information regarding the second parking lot P2. In detail, the processing unit 13C receives the registration application for the extended parking lot from an operator terminal 22 of the second operator. The registration application includes the position information of the second parking lot P2, the name of the second parking lot P2, the access ID of the second parking lot P2, the transaction account number, and the like. When the registration application is confirmed by the first operator and the parking fee payment condition is input by the first operator or the like, the processing unit 13C transmits the parking fee payment condition to the operator terminal 22. Upon receiving a notification indicating the acceptance from the operator terminal 22, the processing unit 13C generates the second parking lot information in which the position information of the second parking lot P2, the name of the second parking lot P2, the access ID of the second parking lot P2, and the transaction account number included in the registration application are associated with the accepted payment condition and the number of the second parking lot P2. In addition, the processing unit 13C accumulates the generated second parking lot information in the accumulation unit 13A, and registers and updates the second parking lot information in the second parking lot management data 12A2 of the accumulation unit 12A.

Note that it is sufficient if the incentive information number included in the second parking lot information is registered in the second parking lot management data 12A2 at the time of the registration processing of the registration application. In addition, the incentive information number included in the second parking lot information of the second parking lot management data 12A2 may be appropriately updated by an operation instruction by an administrator or the like of the first parking lot management server 11.

As the incentive information number included in the second parking lot information of the second parking lot management data 12A2, an incentive information number satisfying a relationship in which a second incentive for encouraging the user R to use the second parking lot P2 is larger than a first incentive for encouraging the user R to use the first parking lot P1 of the use facility F is registered. Specifically, as the incentive information number included in the second parking lot management data 12A2, an incentive information number satisfying a relationship in which a second free parking duration in the case of using the second parking lot P2 is longer than a first free parking duration in the case of using the first parking lot P1 of the use facility F is registered. In addition, as the incentive information number included in the second parking lot management data 12A2, an incentive information number satisfying a relationship in which a second use amount in the use facility F in which the parking fee is free when the user R uses the second parking lot P2 is smaller than a first use amount in the use facility F in which the parking fee is free when the user R uses the first parking lot P1 of the use facility F is registered.

The processing unit 13C of the second parking lot management server 13 executes the above processing each time a registration application from a new second operator is received. Therefore, the second parking lot information corresponding to the latest registration application status is registered in the second parking lot management data 12A2 accumulated in the accumulation unit 12A of the integration server 12.

In addition, the processing unit 13C of the second parking lot management server 13 acquires the latest second parking lot information including the position information and the vacancy information of the second parking lot P2 from the second parking lot management system 20, and performs accumulation in the accumulation unit 13A and update of the accumulation unit 12A of the integration server 12. Therefore, in the second parking lot management data 12A2 accumulated in the accumulation unit 12A of the integration server 12, the second parking lot information including the parkable space number that is the latest vacancy information of the second parking lot P2 is registered.

Next, the account server 14 will be described. The account server 14 is an information processing device for managing the personal information of the user R and the vehicle information of the vehicle D of the user R in association with each other.

The account server 14 includes an accumulation unit 14A, a communication unit 14B, and a processing unit 14C. The accumulation unit 14A, the communication unit 14B, and the processing unit 14C are communicably connected.

The accumulation unit 14A accumulates various types of information. The communication unit 14B transmits and receives information to and from another information processing device. The processing unit 14C executes various types of information processing. In the present embodiment, the processing unit 14C of the account server 14 accumulates, in the accumulation unit 14A, the account information in which the personal information included in the user registration information received from the information terminal 50 of the user R is associated with the vehicle information. In addition, the processing unit 14C of the account server 14 accumulates the account information in the accumulation unit 14A and updates the accumulation unit 12A each time new user registration information is acquired from the information terminal 50 of the user R. Therefore, the accumulation unit 12A of the integration server 12 accumulates the user data 12A1 including the latest account information.

The WEB server 15 manages access to the integration server 12 by the information terminal 50 of the user R, display of various types of information on the information terminal 50, and the like.

The WEB server 15 includes an accumulation unit 15A, a communication unit 15B, and a processing unit 15C. The accumulation unit 15A, the communication unit 15B, and the processing unit 15C are communicably connected.

The accumulation unit 15A accumulates various types of information. The communication unit 15B transmits and receives information to and from another information processing device. The processing unit 15C executes various types of information processing. In the present embodiment, the processing unit 15C of the WEB server 15 accesses the first parking lot management system 10 from the information terminal 50 of the user R, distributes a dedicated application to the information terminal 50, and the like. Hereinafter, the application may be referred to as an app.

The dedicated app is a parking lot app for executing processing such as user registration in the first parking lot management system 10, map display, selection of the second parking lot P2, and transmission of the parking position of the vehicle D in the information terminal 50.

In response to a dedicated app download request received from the information terminal 50, the processing unit 15C permits the dedicated app download to the information terminal 50, thereby distributing the dedicated app to the information terminal 50.

Next, the second parking lot management system 20 will be described. The second parking lot management system 20 is a system that manages the second parking lot P2. In a case where the parking lot management system 1 includes a plurality of second parking lots P2, the second parking lot management system 20 is provided for each of the plurality of second parking lots P2.

The second parking lot management system 20 includes the second parking lot server 21 and the operator terminal 22. The second parking lot server 21 and the operator terminal 22 are communicably connected.

The second parking lot server 21 is an information processing device that manages the availability of the second parking lot P2. The second parking lot server 21 includes an accumulation unit 21A, a communication unit 21B, and a processing unit 21C. The accumulation unit 21A, the communication unit 21B, and the processing unit 21C are communicably connected.

The accumulation unit 21A accumulates various types of information. The communication unit 21B transmits and receives information to and from another information processing device. The processing unit 21C executes various types of information processing. In the present embodiment, the processing unit 21C of the second parking lot server 21 acquires the latest second parking lot information of the second parking lot P2 including the position information and the vacancy information of the second parking lot P2 from a sensor or the like provided in the second parking lot P2. Then, the processing unit 21C accumulates the latest second parking lot information in the accumulation unit 21A and transmits the second parking lot information to the first parking lot management server 11.

The operator terminal 22 is an information processing device managed by the second operator of the second parking lot P2. The operator terminal 22 includes an accumulation unit 22A, a communication unit 22B, and a processing unit 22C. The accumulation unit 22A, the communication unit 22B, and the processing unit 22C are communicably connected.

The accumulation unit 22A accumulates various types of information. The communication unit 22B transmits and receives information to and from another information processing device. The processing unit 22C executes various types of information processing. In the present embodiment, the processing unit 22C of the operator terminal 22 performs registration application processing or the like of the second parking lot P2 managed by the second operator of the operator terminal 22 as an extended parking lot of the first parking lot P1. In detail, the processing unit 22C transmits the registration application of the extended parking lot of the second parking lot P2 to the first parking lot management server 11. When the parking fee payment condition is received from the first parking lot management server 11 and the approval operation is performed by the second operator, the processing unit 22C transmits a notification indicating acceptance to the first parking lot management server 11.

Next, the use facility management system 30 will be described. The use facility management system 30 is a system that manages the use facility F. The use facility management system 30 includes, for example, a use facility management server 31 and a store point of sales system (POS) 40 provided for each store.

The use facility management system 30 includes, for example, a POS server 32 or the like. The POS server 32 manages the point of sales information by each of a plurality of store POSs 40.

In the present embodiment, when the parking ticket information is presented by the information terminal 50 of the user R and the store POS 40 receives a shopping payment request in the store provided with the store POS 40, the store POS transmits shopping information and the parking ticket information corresponding to the shopping payment request to the first parking lot management server 11.

Next, the information terminal 50 will be described. The information terminal 50 is an information processing device operated by the user R. In the present embodiment, a form in which the information terminal 50 is a portable information terminal such as a smartphone and a tablet will be described as an example.

The information terminal 50 includes an accumulation unit 50A, a communication unit 50B, a processing unit 50C, and a UI unit 50D. The accumulation unit 50A, the communication unit 50B, the processing unit 50C, and the UI unit 50D are communicably connected.

The accumulation unit 50A accumulates various types of information. The communication unit 50B communicates with another information processing device. The UI unit 50D includes a display function for displaying various types of information and an input function for receiving an operation input by the user R. The display function is, for example, a display. The input function is a keyboard, a pointing device such as a mouse or a pen tablet, or the like. The UI unit 50D may be a touch panel in which the display function and the input function are integrally configured. In the present embodiment, a case where the UI unit 50D is a touch panel will be described as an example.

The processing unit 50C of the information terminal 50 executes various types of information processing. In the present embodiment, the processing unit 50C executes processing such as downloading a parking lot app that is a dedicated app and executing the parking lot app.

Next, the in-vehicle system 60 will be described. The in-vehicle system 60 is executed by one or a plurality of electronic control units (ECUs) or the like mounted on the vehicle D. The in-vehicle system 60 is, for example, a car navigation system 61A, an automated driving ECU 61B, or the like.

The car navigation system 61A is a type of information equipment mounted on the vehicle D, and is a known system that assists the user R who is a driver of the vehicle D by providing route guidance to a destination and the like.

The automated driving ECU 61B is the in-vehicle system 60 that performs automated driving control of the vehicle D of the user R. For example, the automated driving ECU 61B performs automated driving control of the vehicle D of the user R along the route to the destination.

Next, the processing unit 12C of the integration server 12 included in the first parking lot management server 11 will be described in detail.

The processing unit 12C of the integration server 12 includes a search module 12E, a request information acquisition module 12F, a vacancy information acquisition module 12G, a map information generation module 12H, a map information transmission module 12I, a notification acquisition module 12J, a parking ticket information transmission module 12K, a discount calculation module 12L, and an unloading processing module 12M.

Some or all of the search module 12E, the request information acquisition module 12F, the vacancy information acquisition module 12G, the map information generation module 12H, the map information transmission module 12I, the notification acquisition module 12J, the parking ticket information transmission module 12K, the discount calculation module 12L, and the unloading processing module 12M may be implemented by causing a processing device such as a central processing unit (CPU) to execute a program, that is, by software, may be implemented by hardware such as an integrated circuit (IC), or may be implemented by using software and hardware in combination. In addition, at least one of the search module 12E, the request information acquisition module 12F, the vacancy information acquisition module 12G, the map information generation module 12H, the map information transmission module 12I, the notification acquisition module 12J, the parking ticket information transmission module 12K, the discount calculation module 12L, and the unloading processing module 12M may be configured to be mounted on an external information processing device communicably connected to the integration server 12 via the network NW or the like.

Upon receiving a parking request to the use facility F from the information terminal 50 of the user R, the search module 12E searches for the availability of the first parking lot P1. The search module 12E searches for the availability of the first parking lot P1 by searching for information indicating the availability of the first parking lot P1 stored in the accumulation unit 12A. Here, the description will be continued on the assumption that the proportion of the parkable spaces in the first parking lot P1 is equal to or less than a threshold and the first parking lot P1 is congested. As the threshold, it is sufficient if a value by which congestion in the first parking lot P1 can be determined is set in advance. The search module 12E notifies the information terminal 50 of the user R of information indicating non-availability in the first parking lot P1.

The request information acquisition module 12F acquires request information for inquiring about a substitute parking lot of the first parking lot P1 from the information terminal 50 of the user R.

The vacancy information acquisition module 12G acquires vacancy information indicating the availability of the second parking lot P2 at the time point when the request information is acquired from the second parking lot management system 20.

As described above, the second parking lot management server 13 registers, in the accumulation unit 12A of the integration server 12, the vacancy information including the parkable space number indicating the latest availability of the second parking lot P2 managed by the second parking lot management system 20. Therefore, the vacancy information acquisition module 12G acquires vacancy information indicating the availability of the second parking lot P2 at the time point of acquisition of the request information by confirming the presence or absence of registration of the parkable space number included in the second parking lot information of each of the plurality of second parking lots P2 registered in the second parking lot management data 12A2.

Note that the vacancy information acquisition module 12G may transmit, to the second parking lot management system 20 via the second parking lot management server 13, a request for acquiring vacancy information indicating the availability of the second parking lot P2 at the time point of the acquisition of the request information by the request information acquisition module 12F. Then, the vacancy information acquisition module 12G may acquire, as a response to the acquisition request, from the second parking lot management system 20, the vacancy information indicating the availability of the second parking lot P2 at the time point of the acquisition of the request information by the request information acquisition module 12F.

The map information generation module 12H generates map information indicating the second parking lot P2 having a vacancy based on the vacancy information acquired by the vacancy information acquisition module 12G.

The map information includes a message indicating that the second incentive is larger than the first incentive.

For example, the map information generation module 12H generates map information including a message indicating that the second incentive is larger than the first incentive on a parking lot vicinity map including the first parking lot P1 and the second parking lot P2.

As described above, the first incentive is an incentive for encouraging the user R to use the first parking lot P1 of the use facility F. The second incentive is an incentive for encouraging the user R to use the second parking lot P2.

In addition, as described above, the incentive information number satisfying the relationship in which the second incentive is larger than the first incentive is registered as the incentive information number included in the second parking lot information of each of the plurality of second parking lots P2 in the second parking lot management data 12A2.

Therefore, the map information generation module 12H reads the incentive content corresponding to the incentive information number included in the second parking lot information of the second parking lot P2 having a vacancy included in the second parking lot management data 12A2 from the incentive information 12A3 (see FIGS. 3C and 3D). Then, the map information generation module 12H arranges the message including the read incentive content at the position on the map indicated by the position information of the second parking lot P2 corresponding to the incentive information number of the incentive content on the parking lot vicinity map. Through these pieces of processing, the map information generation module 12H generates map information in which a message indicating that the second incentive is larger than the first incentive is arranged on the parking lot vicinity map including the first parking lot P1 and the second parking lot P2.

Specifically, as described above, in the second parking lot management data 12A2, an incentive information number satisfying the relationship in which the second free parking duration in the case of using the second parking lot P2 is longer than the first free parking duration in the case of using the first parking lot P1 of the use facility F is registered.

Therefore, the map information generation module 12H reads the incentive content corresponding to the incentive information number included in the second parking lot information of the second parking lot P2 having a vacancy included in the second parking lot management data 12A2 from the incentive information 12A4 regarding the parking duration (see FIG. 3C). Then, the map information generation module 12H arranges the message including the read incentive content at the position on the map indicated by the position information of the second parking lot P2 corresponding to the incentive information number of the incentive content on the parking lot vicinity map. Through these pieces of processing, the map information generation module 12H generates map information in which a message indicating that the second free parking duration in the case of using the second parking lot P2 is longer than the first free parking duration in the case of using the first parking lot P1 of the use facility F is arranged on the parking lot vicinity map including the first parking lot P1 and the second parking lot P2.

In addition, as described above, in the second parking lot management data 12A2, an incentive information number satisfying the relationship in which the second use amount in the use facility F in which the parking fee is free when the user R uses the second parking lot P2 is smaller than the first use amount in the use facility F in which the parking fee is free when the user R uses the first parking lot P1 of the use facility F is registered.

Therefore, the map information generation module 12H reads the incentive content corresponding to the incentive information number included in the second parking lot information of the second parking lot P2 having a vacancy included in the second parking lot management data 12A2 from the incentive information 12A5 regarding the use facility payment amount (see FIG. 3D). Then, the map information generation module 12H arranges the message including the read incentive content at the position on the map indicated by the position information of the second parking lot P2 corresponding to the incentive information number of the incentive content on the parking lot vicinity map. Through these pieces of processing, the map information generation module 12H generates map information in which a message indicating that the second use amount in the use facility F in which the parking fee is free when the user R uses the second parking lot P2 is smaller than the first use amount in the use facility F in which the parking fee is free when the user R uses the first parking lot P1 of the use facility F is arranged on the parking lot vicinity map including the first parking lot P1 and the second parking lot P2.

The map information transmission module 12I transmits the map information generated by the map information generation module 12H to the information terminal 50 of the user R that is the transmission source of the request information to display the map information on the information terminal 50.

The notification acquisition module 12J acquires a parking notification, which is a notification indicating that the vehicle D of the user R has been parked in the second parking lot P2 indicated in the map information, from the information terminal 50 that has transmitted the map information. The parking notification includes information such as global positioning system (GPS) position information of the vehicle D, account information of the user R, parking time, and parking section number.

When the parking notification is acquired by the notification acquisition module 12J, the parking ticket information transmission module 12K transmits the parking ticket information indicating the parking ticket of the second parking lot P2 available in the use facility F to the information terminal 50 of the user R. The parking ticket information includes the incentive content corresponding to the incentive information number of the second parking lot P2 in which the vehicle D of the user R is parked.

In addition, the parking ticket information transmission module 12K specifies the second parking lot P2 in which the vehicle D is parked from the position information of the vehicle D included in the parking notification acquired from the information terminal 50. Then, the parking ticket information transmission module 12K registers the parking time included in the parking notification and the number of the specified second parking lot P2 in the user data 12A1 in association with the account information included in the parking notification (see FIG. 3A).

When the user R operates the information terminal 50 to present the parking ticket information at the store POS 40 and makes a shopping payment or the like, the parking ticket information and the shopping information are transmitted from the store POS 40 to the first parking lot management server 11. The shopping information includes the shopping amount at the use facility F and the account information of the user R.

The discount calculation module 12L uses the shopping amount included in the shopping information and the parking time corresponding to the account information included in the shopping information to calculate parking fee discount information indicating a parking fee discounted according to an incentive indicated by the incentive content included in the parking ticket information. Then, a notification of the calculated parking fee discount information is given to the information terminal 50 of the user R.

Upon receiving the unloading information from the information terminal 50 of the user R, the unloading processing module 12M performs the final discount calculation and the withdrawal processing. The unloading information includes, for example, GPS position information of the vehicle D, the account information of the user R, an unloading time, and the like. The unloading processing module 12M sets an elapsed time from the parking time corresponding to the account information included in the shopping information to the unloading time as the parking duration, and performs final discount calculation using, as a final parking fee, parking fee discount information indicating the parking fee discounted according to an incentive indicated by the incentive content included in the parking ticket information. Then, the unloading processing module 12M performs the withdrawal processing of withdrawing the calculated parking fee from the account of the user R specified by the account information included in the parking notification. Note that the unloading processing module 12M may perform settlement processing by fee payment instead of the withdrawal processing.

Upon completion of the final discount calculation and the withdrawal processing, the unloading processing module 12M notifies the information terminal 50 of the user R of an unloading permission notification and the final parking fee. In addition, the unloading processing module 12M notifies the second parking lot server 21 of the second parking lot P2 in which the vehicle D has been parked of an instruction of unloading the vehicle D of the user R to which the unloading permission notification has been transmitted and a parking fee transfer processing notification.

Next, an example of a flow of information processing executed by the parking lot management system 1 of the present embodiment will be described.

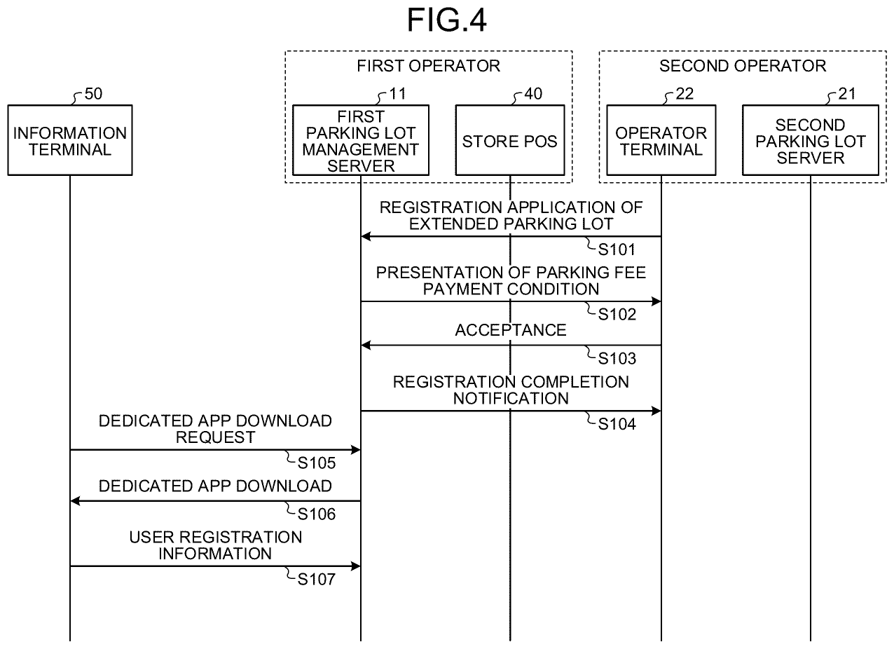

FIG. 4 is a sequence diagram illustrating an example of a flow of pre-processing executed in the parking lot management system 1.

When the registration application for the extended parking lot is made from the operator terminal 22 managed by the second operator to the first parking lot management server 11, the processing unit 13C of the second parking lot management server 13 included in the first parking lot management server 11 receives the registration application for the extended parking lot from the operator terminal 22 of the second operator (Step S101). The registration application includes the position information of the second parking lot P2, the name of the second parking lot P2, the access ID of the second parking lot P2, the transaction account number, and the like.

When the registration application received in Step S101 is confirmed by the first operator and the parking fee payment condition is input, the processing unit 13C of the first parking lot management server 11 presents the parking fee payment condition to the operator terminal 22 (Step S102). When the operator terminal 22 receives the parking fee payment condition, the second operator inputs an acceptance instruction by operating the operator terminal 22 when accepting the presented payment condition. When the acceptance instruction is input, the operator terminal 22 transmits a notification indicating the acceptance to the first parking lot management server 11 (Step S103).

Upon receiving the notification indicating the acceptance from the operator terminal 22, the processing unit 13C of the first parking lot management server 11 generates the second parking lot information in which the position information of the second parking lot P2, the name of the second parking lot P2, the access ID of the second parking lot P2, and the transaction account number included in the registration application received in Step S101 are associated with the accepted payment condition and the number of the second parking lot P2. In addition, the processing unit 13C accumulates the generated second parking lot information in the accumulation unit 13A, and registers and updates the second parking lot information in the second parking lot management data 12A2 of the accumulation unit 12A. Then, the processing unit 13C of the first parking lot management server 11 transmits a registration completion notification indicating registration completion to the operator terminal 22 (Step S104).

By the registration processing of the registration application in Steps S101 to S104, the second parking lot information is registered in the second parking lot management data 12A2 of the accumulation unit 12A of the first parking lot management server 11 for each second parking lot P2 according to the registration application (see FIG. 3B).

On the other hand, when a dedicated app download request is transmitted from the information terminal 50 according to an operation instruction or the like of the information terminal 50 by the user R, the processing unit 15C of the WEB server 15 included in the first parking lot management server 11 receives the dedicated app download request (Step S105). When the processing unit 15C permits download of the dedicated app to the information terminal 50, the parking lot app as the dedicated app is downloaded to the information terminal 50 (Step S106).

When the parking lot app is downloaded to the information terminal 50, the parking lot app is installed in the information terminal 50, and the information terminal 50 enters a state in which various processing such as user registration in the first parking lot management server 11, map display, selection of the second parking lot P2, and transmission of the parking position of the vehicle D can be executed.

When the user registration information is transmitted to the first parking lot management server 11 according to the operation instruction of the information terminal 50 by the user R, the processing unit 14C of the account server 14 included in the first parking lot management server 11 receives the user registration information from the information terminal 50 of the user R (Step S107). The processing unit 14C of the first parking lot management server 11 registers the account information in which the personal information included in the received user registration information and the vehicle information are associated with each other in the accumulation unit 14A and the user data 12A1 of the accumulation unit 12A. Therefore, the accumulation unit 12A of the integration server 12 accumulates the user data 12A1 including the latest account information.

Next, an example of a flow of information provision processing executed by the parking lot management system 1 of the present embodiment will be described.

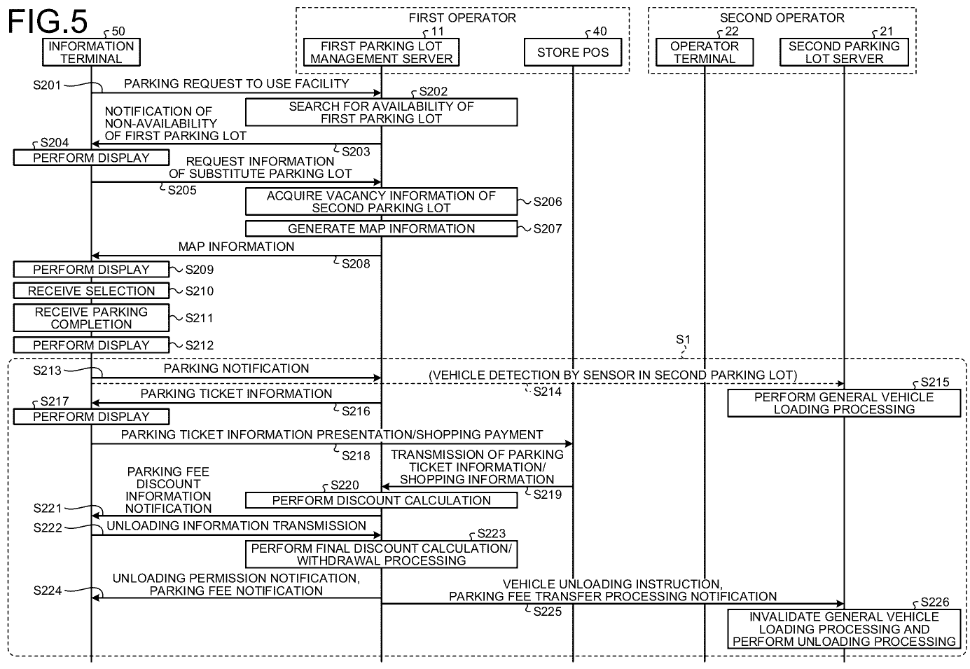

FIG. 5 is a sequence diagram illustrating an example of a flow of information provision processing executed in the parking lot management system 1.

When a parking request to the use facility F is input via the parking lot app by the operation of the information terminal 50 by the user R, the parking request to the use facility F is transmitted from the information terminal 50 to the first parking lot management server 11 (Step S201). The processing unit 12C of the integration server 12 included in the first parking lot management server 11 that has received the parking request to the use facility F searches for the availability of the first parking lot P1 (Step S202). Here, the description will be continued on the assumption that the first parking lot P1 is congested and there is no vacancy. The processing unit 12C of the first parking lot management server 11 notifies the information terminal 50 of the user R of information indicating non-availability in the first parking lot P1 (Step S203).

The processing unit 50C of the information terminal 50 that has received the information indicating non-availability in the first parking lot P1 displays the information indicating non-availability in the first parking lot P1 on the UI unit 50D (Step S204).

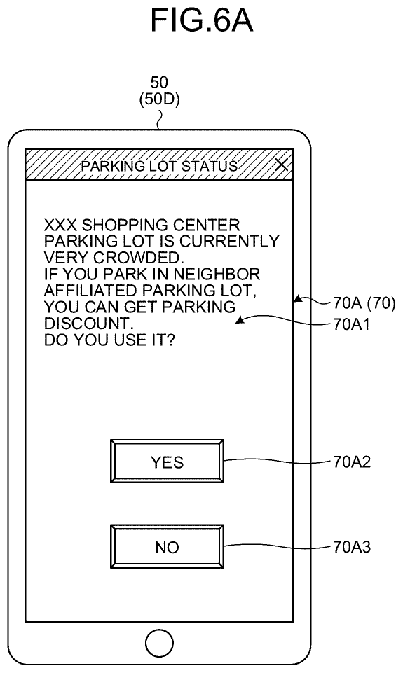

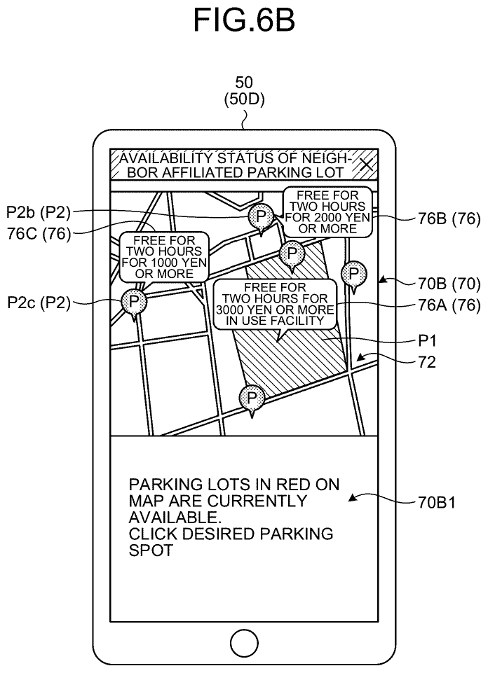

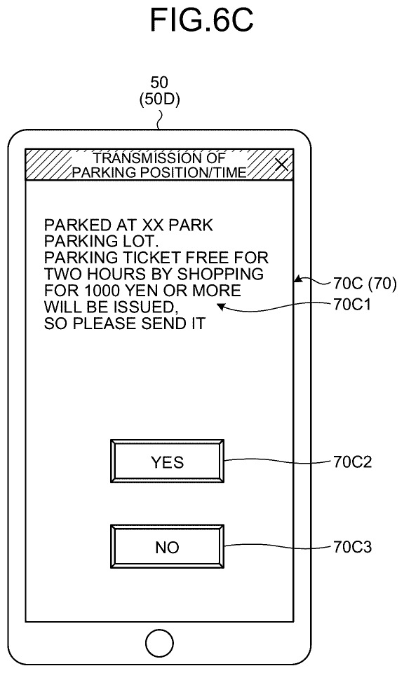

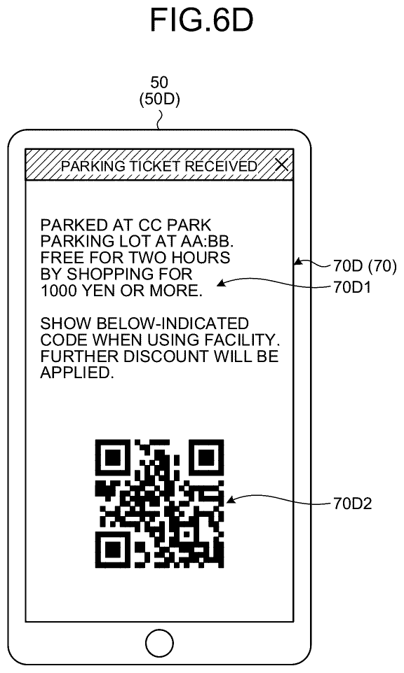

FIG. 6A is a schematic diagram of an example of a display screen 70A displayed on the UI unit 50D of the information terminal 50. The display screen 70A is an example of a display screen 70 displayed on the UI unit 50D of the information terminal 50.

The display screen 70A includes information 70A1 that prompts parking in the second parking lot P2 because the first parking lot P1 is congested, and a “YES” button 70A2 and a “NO” button 70A3 for receiving the presence or absence of the acceptance of the information 70A1 by the user R. Here, the description will be continued on the assumption that the “YES” button 70A2 is operated by the user R.

Returning to FIG. 5, the description will be continued. When the “YES” button 70A2 indicating the acceptance of the information 70A1 prompting parking in the second parking lot P2 because the first parking lot P1 is congested is operated via the display screen 70A, the information terminal 50 transmits request information inquiring about the substitute parking lot of the first parking lot P1 to the first parking lot management server 11 (Step S205).

The processing unit 12C of the first parking lot management server 11 that has acquired the request information from the information terminal 50 acquires the vacancy information indicating the availability of the second parking lot P2 at the time point when the request information is acquired in Step S205 (Step S206).

Then, the processing unit 12C of the first parking lot management server 11 generates map information indicating the second parking lot P2 having a vacancy based on the vacancy information acquired in Step S206 (Step S207). Then, the processing unit 12C of the first parking lot management server 11 transmits the map information generated in Step S207 to the information terminal 50 that is the transmission source of the request information acquired in Step S205 to display the map information on the information terminal 50 (Step S208).

The processing unit 50C of the information terminal 50 that has received the map information displays the received map information on the UI unit 50D (Step S209).

FIG. 6B is a schematic diagram illustrating an example of a display screen 70B displayed on the information terminal 50 in Step S209. The display screen 70B is an example of the display screen 70.

The display screen 70B includes map information 72 generated by the first parking lot management server 11. The map information 72 includes a message 76 indicating that the second incentive is larger than the first incentive. For example, on the display screen 70B, the map information 72 in which the message 76 indicating that the second incentive is larger than the first incentive is superimposed on a parking lot vicinity map 74 is displayed.

FIG. 6B illustrates, as an example, the parking lot vicinity map 74 including an image indicating the first parking lot P1 and an image indicating each of two second parking lots P2: a second parking lot P2b and a second parking lot P2c. In addition, as the message 76, a message 76A indicating the first incentive for encouraging the user R to use the first parking lot P1: “free for 2 hours for 3000 yen or more in the use facility”, a message 76B indicating the second incentive for encouraging the user R to use the second parking lot P2: “free for 2 hours for 2000 yen or more”, and a message 76C indicating “free for 2 hours for 1000 yen or more” are illustrated.

That is, as illustrated in FIG. 6B, the map information 72 including the message 76 indicating that the second incentive is larger than the first incentive is displayed on the information terminal 50 of the user R. In detail, as illustrated in FIG. 6B, on the map information 72, a message 76 is included indicating that the second use amount in the use facility F in which the parking fee is free when the user R uses the second parking lot P2 is smaller than the first use amount in the use facility F in which the parking fee is free when the user R uses the first parking lot P1 of the use facility F. Note that, as described above, on the map information 72, a message 76 may be included indicating that the second free parking duration in the case of using the second parking lot P2 is longer than the first free parking duration in the case of using the first parking lot P1 of the use facility F.

In addition, the display screen 70B may include information 70B1 prompting the user R to select the position information of the second parking lot P2 where the user R wants to park. The user R operates the UI unit 50D while visually recognizing the display screen 70B to select the second parking lot P2 where the user R wants to park among the plurality of second parking lots P2 displayed on the map information 72.

Returning to FIG. 5, the description will be continued. When the second parking lot P2 where the user R wants to park is selected by the operation instruction of the user R, the processing unit 50C of the information terminal 50 receives the selection of the position information of the second parking lot P2 (Step S210). The map information 72 includes the position information of the second parking lot P2, and when the user R selects the display region of the desired second parking lot P2 displayed, the processing unit 50C of the information terminal 50 receives the position information of the selected second parking lot P2.

Then, the vehicle D is parked in the selected second parking lot P2 by control of the vehicle D by the user R or the like, and a signal indicating parking completion is input by an operation instruction of the UI unit 50D by the user R or the like. Then, the processing unit 50C of the information terminal 50 receives the signal indicating the parking completion from the UI unit 50D (Step S211). Upon receiving the signal indicating the parking completion, the processing unit 50C of the information terminal 50 displays the display screen 70 for transmitting the parking position and the time on the UI unit 50D (Step S212).

FIG. 6C is a schematic diagram illustrating an example of a display screen 70C displayed on the information terminal 50 in Step S212. The display screen 70C is an example of the display screen 70.

The display screen 70C includes information 70C1 for prompting a notification for issuance of parking ticket information after completion of parking in the second parking lot P2, and a “YES” button 70C2 and a “NO” button 70C3 for receiving the presence or absence of the acceptance of the information 70C1 by the user R. Here, the description will be continued on the assumption that the “YES” button 70C2 is operated by the user R.

Returning to FIG. 5, the description will be continued. When the “YES” button 70C2 indicating the acceptance of the information 70C1 prompting the notification for issuance of parking ticket information is operated via the display screen 70C, the information terminal 50 transmits the parking notification including information such as the GPS position information of the vehicle D, the account information of the user R, the parking time, and the parking section number to the first parking lot management server 11 (Step S213).

In addition, the second parking lot server 21 of the second parking lot P2 in which the vehicle D is parked is notified of detection information of the vehicle D from various sensors provided in the second parking lot P2 (Step S214). When receiving the detection information of the vehicle D, the processing unit 21C of the second parking lot server 21 performs general vehicle loading processing (Step S215). The general vehicle loading processing is processing of raising a flap plate provided in the space in which the vehicle D is parked in the second parking lot P2, processing of issuing a parking ticket, and the like.

Upon acquiring the parking notification from the information terminal 50, the processing unit 12C of the first parking lot management server 11 transmits parking ticket information indicating a parking ticket of the second parking lot P2 available in the use facility F to the information terminal 50 (Step S216). As described above, the parking ticket information includes the incentive content corresponding to the incentive information number of the second parking lot P2 in which the vehicle D of the user R is parked.

The processing unit 50C of the information terminal 50 that has received the parking ticket information from the first parking lot management server 11 displays the received parking ticket information on the UI unit 50D (Step S217).

FIG. 6D is a schematic diagram illustrating an example of a display screen 70D displayed on the information terminal 50 in Step S217. The display screen 70D is an example of the display screen 70.

On the display screen 70D, information 70D1 indicating the incentive content included in the parking ticket information and a quick response (QR) code (registered trademark) 70D2 indicating at least the incentive content included in the parking ticket information are displayed. Note that it is sufficient if the parking ticket information is displayed on the display screen 70D, and the display form thereof is not limited to the QR code.

Returning to FIG. 5, the description will be continued. The user R performs shopping at the use facility F, presents the QR code 70D2 included in the display screen 70D illustrated in FIG. 6D at the store POS 40 by operating the information terminal 50, and performs shopping payment or the like (Step S218). Then, the parking ticket information indicated by the presented QR code 70D2 and the shopping information are transmitted from the store POS 40 to the first parking lot management server 11 (Step S219). The shopping information includes the shopping amount at the use facility F and the account information of the user R.

The processing unit 12C of the first parking lot management server 11 uses the shopping amount included in the shopping information acquired from the store POS 40 and the parking time corresponding to the account information included in the shopping information to calculate parking fee discount information indicating a parking fee discounted according to an incentive indicated by the incentive content included in the parking ticket information (Step S220). Then, the processing unit 12C of the first parking lot management server 11 notifies the information terminal 50 of the user R of the calculated parking fee discount information (Step S221).

The user R operates the UI unit 50D of the information terminal 50 at the time of unloading of the vehicle D to input a signal indicating the unloading of the vehicle D. Upon receiving the signal indicating the unloading of the vehicle D, the processing unit 50C of the information terminal 50 transmits the unloading information including the GPS position information of the vehicle D, the account information of the user R, the unloading time, and the like to the first parking lot management server 11 (Step S222).

Upon acquiring the unloading information from the information terminal 50, the processing unit 12C of the first parking lot management server 11 performs the final discount calculation and the withdrawal processing (Step S223). Then, the processing unit 12C of the first parking lot management server 11 notifies the information terminal 50 of the user R of the unloading permission notification and the final parking fee (Step S224). In addition, the unloading processing module 12M notifies the second parking lot server 21 of the second parking lot P2 in which the vehicle D has been parked of an instruction of unloading the vehicle D of the user R to which the unloading permission notification has been transmitted and a parking fee transfer processing notification (Step S225).

The processing unit 21C of the second parking lot server 21 invalidates the general vehicle loading processing performed in Step S215, and performs the unloading processing related to the unloading of the vehicle D, such as the processing of lowering the flap plate provided in the space in which the vehicle D is parked in the second parking lot P2 and the processing of opening the gate (Step S226). Then, this sequence is ended.

Next, an example of a flow of information processing executed by the first parking lot management server 11 of the present embodiment will be described.

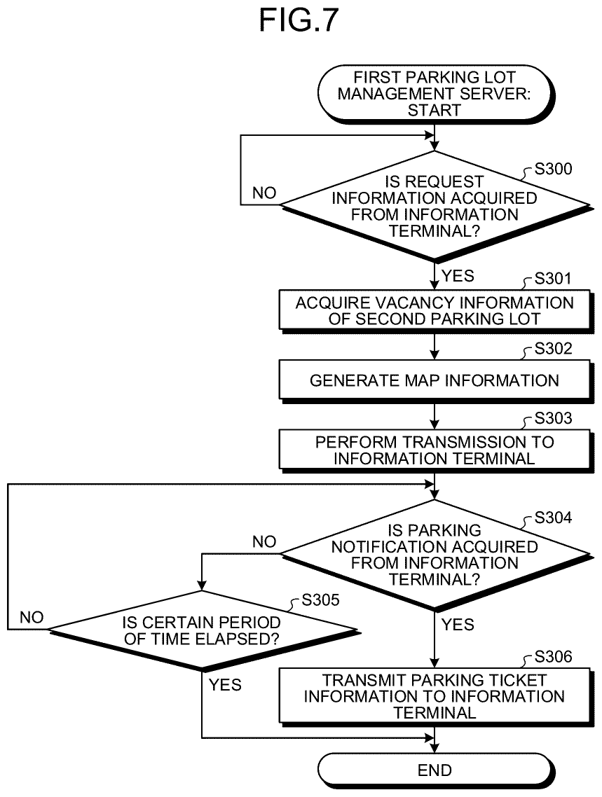

FIG. 7 is a flowchart illustrating an example of a flow of information processing executed in the first parking lot management server 11 of the present embodiment.

The request information acquisition module 12F of the processing unit 12C of the first parking lot management server 11 determines whether the request information has been acquired from the information terminal 50 of the user R (Step S300). The request information acquisition module 12F repeats the negative determination (Step S300: No) until it is determined that the request information has been acquired (Step S300: Yes). When it is determined that the request information has been acquired (Step S300: Yes), the processing proceeds to Step S301.

In Step S301, the vacancy information acquisition module 12G of the processing unit 12C of the first parking lot management server 11 acquires the vacancy information indicating the availability of the second parking lot P2 at the time point when the request information is acquired in Step S300 (Step S301).

Then, the map information generation module 12H of the processing unit 12C of the first parking lot management server 11 generates map information 72 indicating the second parking lot P2 having a vacancy based on the vacancy information acquired in Step S301 (Step S302). The map information 72 includes a message 76 indicating that the second incentive is larger than the first incentive.

The map information transmission module 12I of the processing unit 12C of the first parking lot management server 11 transmits the map information 72 generated in Step S302 to the information terminal 50 that is the transmission source of the request information acquired in Step S300 (Step S303).

The notification acquisition module 12J of the processing unit 12C of the first parking lot management server 11 determines whether the parking notification has been acquired from the information terminal 50 (Step S304). When a negative determination is made in Step S304 (Step S304: No), the processing proceeds to Step S305.

In Step S305, the notification acquisition module 12J of the processing unit 12C determines whether a certain period of time has elapsed since the map information 72 was transmitted to the information terminal 50 in Step S303 (Step S305). When a negative determination is made in Step S305 (Step S305: No), the processing returns to Step S304. When an affirmative determination is made in Step S305 (Step S305: Yes), this routine is ended.

When an affirmative determination is made in Step S304 (Step S304: Yes), the processing proceeds to Step S306. In Step S306, the parking ticket information transmission module 12K of the processing unit 12C of the first parking lot management server 11 transmits the parking ticket information indicating a parking ticket of the second parking lot P2 available in the use facility F to the information terminal 50 (Step S306). Then, this routine is ended.

As described above, the information provision method and the parking lot management system 1 of the present embodiment are the information provision method and the parking lot management system 1 in the first parking lot management system 10 that communicates with the information terminal 50 of the user R and manages the availability of the first parking lot P1 provided in the use facility F.

The information provision method and the parking lot management system 1 according to the present embodiment acquire request information inquiring about a substitute parking lot of the first parking lot P1 from the information terminal 50 of the user R, acquire vacancy information indicating the availability of the second parking lot P2 at the time point when the request information is acquired from the second parking lot management system 20 that manages the availability of the second parking lot P2 managed by the second operator different from the first operator of the use facility F and existing outside the area of the use facility F, and generate the map information 72 indicating the second parking lot P2 having a vacancy based on the vacancy information. The map information 72 includes the message 76 indicating that the second incentive for encouraging the user R to use the second parking lot P2 is larger than the first incentive for encouraging the user R to use the first parking lot P1 of the use facility F. The information provision method transmits the map information 72 to the information terminal 50 to display the map information 72 on the information terminal 50.

In addition, the information provision method acquires request information inquiring about a substitute parking lot of the first parking lot P1 from the information terminal 50 of the user R, acquires vacancy information indicating the availability of the second parking lot P2 at the time point when the request information is acquired from the second parking lot management system 20 that manages the availability of the second parking lot P2 managed by the second operator different from the first operator of the use facility F and existing outside the area of the use facility F, and generates the map information 72 indicating the second parking lot P2 having a vacancy based on the vacancy information. On the map information 72, the message 76 is included indicating that the second free parking duration in the case of using the second parking lot P2 is longer than the first free parking duration in the case of using the first parking lot P1 of the use facility F. The information provision method transmits the map information 72 to the information terminal 50 to display the map information 72 on the information terminal 50.

In addition, the information provision method acquires request information inquiring about a substitute parking lot of the first parking lot P1 from the information terminal 50 of the user R, acquires vacancy information indicating the availability of the second parking lot P2 at the time point when the request information is acquired from the second parking lot management system 20 that manages the availability of the second parking lot P2 managed by the second operator different from the first operator of the use facility F and existing outside the area of the use facility F, and generates the map information 72 indicating the second parking lot P2 having a vacancy based on the vacancy information. On the map information 72, the message 76 is included indicating that the second use amount in the use facility F in which the parking fee is free when the user R uses the second parking lot P2 is smaller than the first use amount in the use facility F in which the parking fee is free when the user R uses the first parking lot P1 of the use facility F.

Here, the use facility F such as a commercial facility often has a parking lot (first parking lot P1) of the use facility F. However, at the time of congestion, there is a case where congestion occurs to such an extent that a traffic jam occurs on a road to the first parking lot P1 of the use facility F. Parking lots (second parking lots P2) operated by second operators different from the first operator that is an operating operator of the use facility F may be scattered around the use facility F. However, in the conventional art, there is a case where the parking lots of the second operators are not affiliated with the use facility F. This is because there is no platform with which the use facility F easily affiliates with the second operators of the parking lots around the use facility F. For this reason, in the conventional art, there is no means for the user R to know which parking lot is the second parking lot P2 affiliated with the use facility F.

In addition, it is also a problem whether an increase in sales of the use facility F can be expected if the use facility F affiliates with the second operator around the use facility F. In addition, how many users R use the affiliated parking lot away from the use facility F also becomes a problem.

As conventional art, a system that enables alternative use of a parking lot among a plurality of parking lots is disclosed. However, in the conventional art, it is necessary to newly install an exchange machine for sharing parking lots, and a parking lot that can be used as an alternative is not provided to the user R in an easy-to-understand manner, and there is a case where a traffic jam in the vicinity of the use facility F during congestion is not alleviated.

On the other hand, the information provision method of the present embodiment, upon acquiring request information inquiring about a substitute parking lot of the first parking lot P1 from the information terminal 50 of the user R, acquires vacancy information indicating the availability of the second parking lot P2 managed by the second operator different from the first operator of the use facility F and existing outside the area of the use facility F at the time point when the request information is acquired, and generates the map information 72 indicating the second parking lot P2 having a vacancy based on the vacancy information. Then, the information provision method and the parking lot management system 1 of the present embodiment transmits the generated map information 72 to the information terminal 50 to display the map information 72 on the information terminal 50.

Therefore, the user R of the information terminal 50 can easily know which second parking lot P2 is affiliated with the use facility F according to the map information 72.

In addition, the map information 72 includes the message 76 indicating that the second incentive for encouraging the user R to use the second parking lot P2 is larger than the first incentive for encouraging the user R to use the first parking lot P1 of the use facility F.

Alternatively, on the map information 72, the message 76 is included indicating that the second free parking duration in the case of using the second parking lot P2 is longer than the first free parking duration in the case of using the first parking lot P1 of the use facility F.

Alternatively, on the map information 72, the message 76 is included indicating that the second use amount in the use facility F in which the parking fee is free when the user R uses the second parking lot P2 is smaller than the first use amount in the use facility F in which the parking fee is free when the user R uses the first parking lot P1 of the use facility F.

Therefore, as the number of users R who use the second parking lot P2 other than the first parking lot P1 of the use facility F increases, the sales of the use facility F is expected to increase, and it is easy to prompt the user to use the second parking lot P2 away from the use facility F.

Accordingly, the information provision method and the parking lot management system 1 of the present embodiment can alleviate a traffic jam in the vicinity of the use facility F during congestion.

In addition, by the information provision method and with the parking lot management system 1 of the present embodiment, the user R can easily park in the second parking lot P2 and can use the use facility F even if the first parking lot P1 of the use facility F is full. In addition, by the information provision method and with the parking lot management system 1 of the present embodiment, the use facility F can increase the number of customers of the use facility F without expanding the first parking lot P1.

Further, the information provision method of the present embodiment, when a notification indicating that the vehicle D of the user R is parked in the second parking lot P2 indicated in the map information 72 is acquired from the information terminal 50 of the user R, transmits parking ticket information indicating a parking ticket of the second parking lot P2 available in the use facility F to the information terminal 50 of the user R.

In this manner, the parking ticket of the second parking lot P2 around the use facility F can be used in the use facility F. Therefore, the information provision method of the present embodiment can promote the use of the second parking lot P2 around the use facility F and alleviate congestion that causes a traffic jam on the road to the first parking lot P1 of the use facility F during congestion of the use facility F.

### Second Embodiment

In the present embodiment, an information provision method in cooperation with a car navigation system 61A of a vehicle D in a parking lot management system 1 will be described.

The parking lot management system 1 of the present embodiment is similar to that of the first embodiment (see FIGS. 1 and 2). As illustrated in FIG. 2, in the present embodiment, a mode in which at least the car navigation system 61A is mounted as an in-vehicle system 60 on the vehicle D will be described. As described above, the car navigation system 61A is a type of information equipment mounted on the vehicle D, and is a system that assists a user R who is a driver of the vehicle D by providing route guidance to a destination and the like.

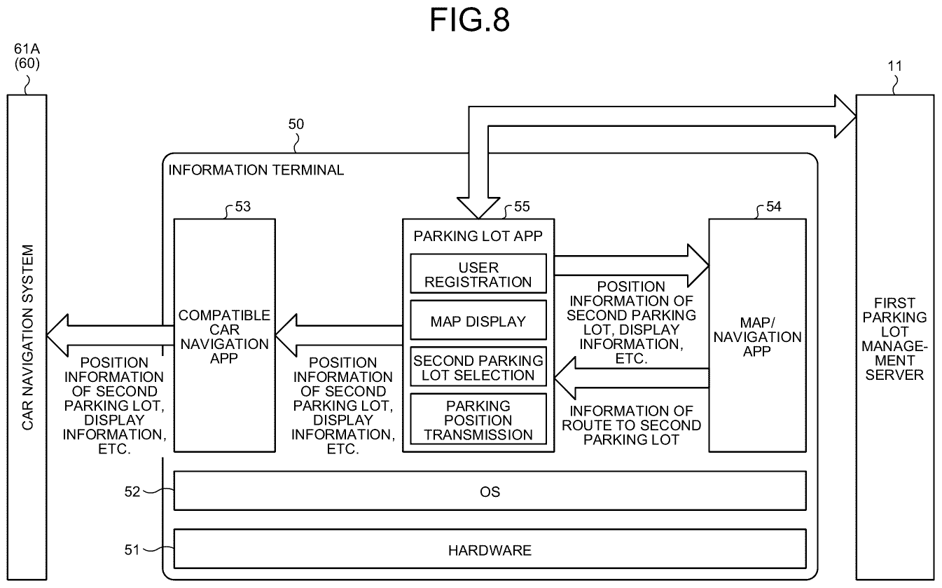

FIG. 8 is a schematic diagram of an example of a cooperative configuration of the car navigation system 61A, an information terminal 50, and a first parking lot management server 11.

The information terminal 50 includes hardware 51, an operating system (OS) 52, and a compatible car navigation app 53, a map/navigation app 54, and a parking lot app 55, which are apps.

The hardware 51 is various types of hardware provided in the information terminal 50. The compatible car navigation app 53, the map/navigation app 54, and the parking lot app 55, which are apps, are application programs.

The parking lot app 55 is the aforementioned parking lot app, i.e., a dedicated app for executing, such as, user registration in the first parking lot management system 10, map display, selection of a second parking lot P2, and transmission of the parking position of the vehicle D in the information terminal 50. The information terminal 50 and the first parking lot management server 11 communicate various types of information via the parking lot app 55.

The compatible car navigation app 53 is an application that communicates with the car navigation system 61A via Bluetooth or the like and can set a destination from the information terminal 50. In the present embodiment, the compatible car navigation app 53 has a function of transmitting the position information of the second parking lot P2 received from the parking lot app 55, the display information displayed on the car navigation system 61A, and the like to the car navigation system 61A.

The map/navigation app 54 is a known app having functions such as displaying a map image and generating route information. In the present embodiment, the map/navigation app 54 acquires position information of the second parking lot P2, the display information, and the like from the parking lot app 55, generates route information to the second parking lot P2, and transmits the route information to the parking lot app 55.

Next, an example of a flow of information provision processing in cooperation with the car navigation system 61A of the vehicle D in the parking lot management system 1 of the present embodiment will be described.

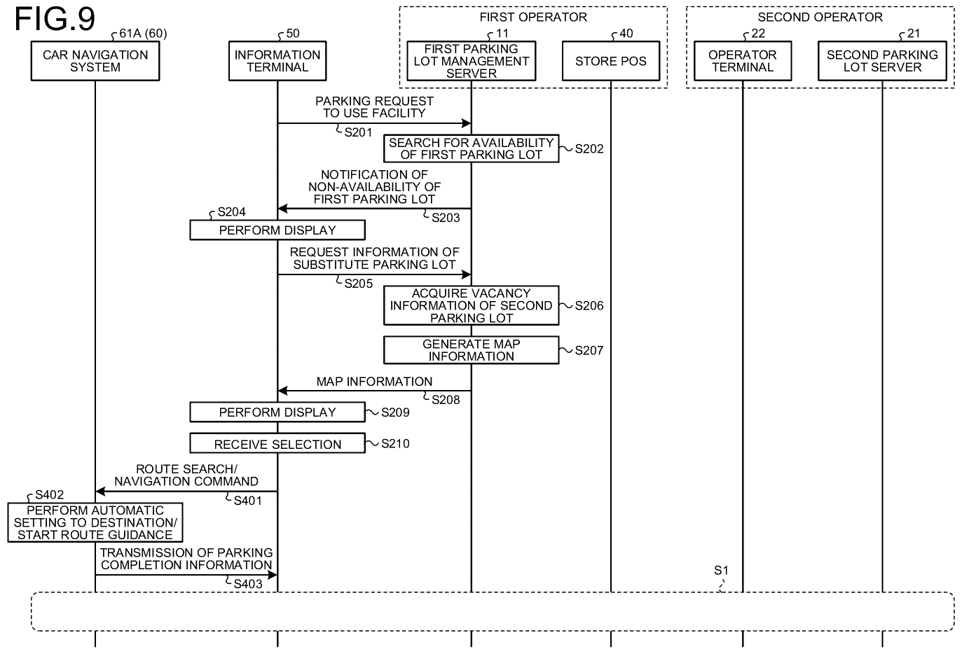

FIG. 9 is a sequence diagram illustrating an example of a flow of information provision processing in cooperation with the car navigation system 61A of the vehicle D.

The information terminal 50 and the first parking lot management server 11 execute processing of Steps S201 to S210. The processing of Steps S201 to S210 is similar to that of the first embodiment (see FIG. 5). That is, a processing unit 12C of the first parking lot management server 11 that has received a parking request to a use facility F from the information terminal 50 searches for the availability of a first parking lot P1 (Steps S201 and S202). Then, the processing unit 12C of the first parking lot management server 11 notifies the information terminal 50 of information indicating non-availability in the first parking lot P1 to display the information on the information terminal 50 (Steps S203 and S204).

Upon acquiring request information inquiring about a substitute parking lot of the first parking lot P1 from the information terminal 50 (Step S205), the processing unit 12C of the first parking lot management server 11 acquires vacancy information indicating the availability of the second parking lot P2 at the time point when the request information is acquired (Step S206). Then, the processing unit 12C of the first parking lot management server 11 generates map information 72 indicating the second parking lot P2 having a vacancy based on the vacancy information acquired in Step S206 (Step S207). Then, the processing unit 12C of the first parking lot management server 11 transmits the map information 72 generated in Step S207 to the information terminal 50 that is the transmission source of the request information acquired in Step S205 to display the map information 72 on the information terminal 50 (Step S208).

A processing unit 50C of the information terminal 50 that has received the map information 72 displays the received map information 72 on a UI unit 50D (Step S209). Then, the processing unit 50C of the information terminal 50 receives selection of the position information of the second parking lot P2 where the user R wants to park among a plurality of second parking lots P2 displayed on the map information 72 (Step S210).

In the present embodiment, the position information of the second parking lot P2 selected from the map information 72 on the information terminal 50 is used to be output as a destination to the car navigation system 61A of the user R associated with the information terminal 50.

In detail, the processing unit 50C of the information terminal 50 transmits, to the car navigation system 61A, a route search/navigation command in which the position information of the second parking lot P2 the selection of which has been received in Step S210 is set as the destination (Step S401).

The car navigation system 61A that has received the route search/navigation command from the information terminal 50 automatically sets the position information of the second parking lot P2 indicated by the route search/navigation command as a destination, and starts route guidance to the destination (Step S402).

Then, when the vehicle D arrives at the second parking lot P2, which is the set destination, the car navigation system 61A transmits, to the information terminal 50, parking completion information indicating that the vehicle has been parked in the second parking lot P2 indicated by the position information received in Step S401 (Step S403). The parking completion information includes GPS position information indicating the parking position of the vehicle D, parking time, a parking section number, and the like.

Then, similarly to the first embodiment, the parking lot management system 1 executes the processing of Step S1 (see also FIG. 5), which is the processing of Steps S213 to S226, and ends this sequence.

Next, an example of a flow of information processing executed by the information terminal 50 of the present embodiment will be described.

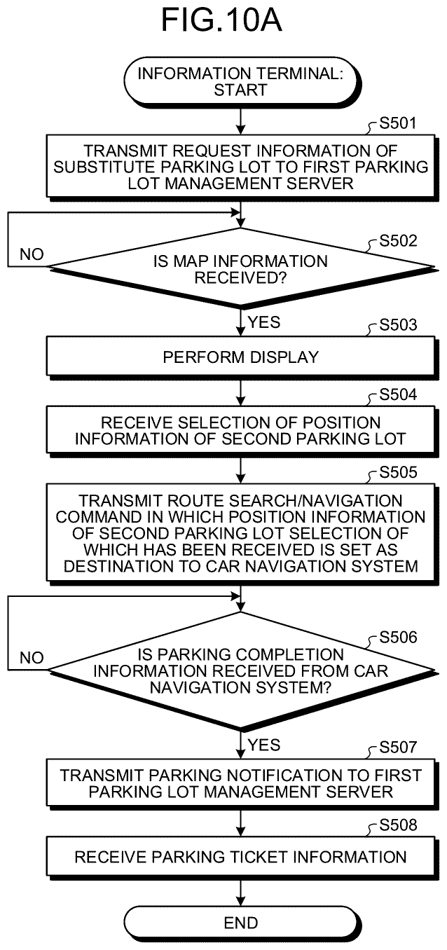

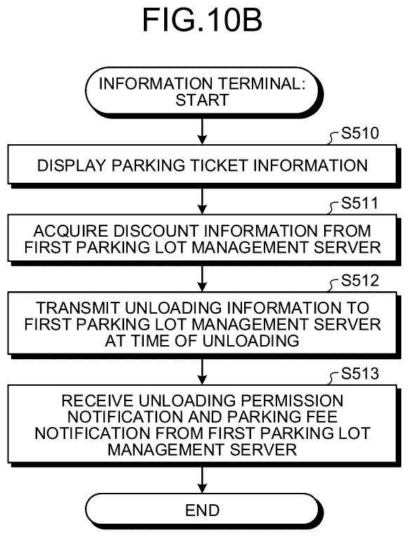

FIG. 10A is a flowchart of an example of a flow of information processing executed in the information terminal 50 of the present embodiment.

The processing unit 50C of the information terminal 50 transmits the request information of the substitute parking lot to the first parking lot management server 11 (Step S501). The processing unit 50C repeats a negative determination (Step S502: No) until the map information 72 is received from the first parking lot management server 11 (Step S502: Yes). Upon receiving the map information 72 from the first parking lot management server 11 (Step S502: Yes), the processing unit 50C displays the received map information 72 on the UI unit 50D (Step S503). Therefore, for example, the map information 72 illustrated in FIG. 6B is displayed on the UI unit 50D of the information terminal 50.

The processing unit 50C of the information terminal 50 receives selection of the position information of the second parking lot P2 where the user R wants to park among the plurality of second parking lots P2 displayed on the map information 72 (Step S504).

The processing unit 50C of the information terminal 50 transmits, to the car navigation system 61A, a route search/navigation command in which the position information of the second parking lot P2 the selection of which has been received in Step S504 is set as the destination (Step S505). Therefore, the position information of the second parking lot P2 selected from the map information 72 on the information terminal 50 is used to be output as a destination to the car navigation system 61A of the user R associated with the information terminal 50.

Next, the processing unit 50C of the information terminal 50 determines whether parking completion information including the GPS position information indicating the parking position of the vehicle D, the parking time, the parking section number, and the like has been received from the car navigation system 61A (Step S506). The processing unit 50C repeats a negative determination (Step S506: No) until an affirmative determination is made in Step S506 (Step S506: Yes). When an affirmative determination is made in Step S506 (Step S506: Yes), the processing proceeds to Step S507.

In Step S507, the processing unit 50C of the information terminal 50 transmits, to the first parking lot management server 11, a parking notification including information such as the GPS position information of the vehicle D, the parking time, and the parking section number included in the parking completion information received in Step S506, and the account information of the user R stored in the information terminal 50 (Step S507). Then, the processing unit 50C of the information terminal 50 receives the parking ticket information from the first parking lot management server 11 (Step S508). Then, this routine is ended.

Next, an example of a flow of information processing after the reception of the parking ticket information executed by the information terminal 50 of the present embodiment will be described.

FIG. 10B is a flowchart of an example of a flow of information processing after reception of parking ticket information executed in the information terminal 50 of the present embodiment.

The processing unit 50C of the information terminal 50 displays the parking ticket information received from the first parking lot management server 11 on the UI unit 50D (Step S510). Therefore, for example, a QR code 70D2 indicating parking ticket information illustrated in FIG. 6D is displayed on the information terminal 50.

The user R performs shopping at the use facility F, presents the QR code 70D2 included in a display screen 70D illustrated in FIG. 6D at a store POS 40 by operating the information terminal 50, and performs shopping payment or the like. Then, the parking ticket information indicated by the presented QR code 70D2 and the shopping information are transmitted from the store POS 40 to the first parking lot management server 11. Then, the processing unit 12C of the first parking lot management server 11 calculates parking fee discount information indicating a parking fee discounted according to an incentive, and notifies the information terminal 50 of the user R of the calculated parking fee discount information.

The processing unit 50C of the information terminal 50 acquires the parking fee discount information from the first parking lot management server 11 (Step S511). The processing unit 50C of the information terminal 50 acquires the parking fee discount information from the first parking lot management server 11 each time the user R presents the QR code 70D2 at the store POS 40. The processing unit 50C of the information terminal 50 may display the acquired parking fee discount information on the UI unit 50D.

The user R operates the UI unit 50D of the information terminal 50 at the time of unloading of the vehicle D to input a signal indicating the unloading of the vehicle D. Upon receiving a signal indicating unloading of the vehicle D from the UI unit 50D, the processing unit 50C of the information terminal 50 transmits the unloading information including the GPS position information of the vehicle D, the account information of the user R, the unloading time, and the like to the first parking lot management server 11 (Step S512).

Then, upon receiving an unloading permission notification and a final parking fee notification from the first parking lot management server 11 (Step S513), the processing unit 50C of the information terminal 50 displays the unloading permission notification and the final parking fee on the UI unit 50D. Upon confirming the reception of the unloading permission notification, the user R operates and unloads the vehicle D from the second parking lot P2. Then, this routine is ended.

As described above, in the information provision method of the present embodiment, the information terminal 50 selects the position information of the second parking lot P2 from the map information 72, and the position information of the second parking lot P2 is used in the information terminal 50 so as to be output as a destination to the car navigation system 61A of the user R associated with the information terminal 50.

Therefore, the information provision method of the present embodiment can improve the convenience of the user R by the cooperation with the car navigation system 61A in addition to the effects of the first embodiment.

### Third Embodiment

In the present embodiment, an information provision method in cooperation with an automated driving ECU 61B of a vehicle D in a parking lot management system 1 will be described.

The parking lot management system 1 of the present embodiment is similar to that of the first embodiment (see FIGS. 1 and 2). As illustrated in FIG. 2, in the present embodiment, a mode in which at least the automated driving ECU 61B is mounted as an in-vehicle system 60 on the vehicle D will be described. As described above, the automated driving ECU 61B is the in-vehicle system 60 that performs automated driving control of the vehicle D of the user R. For example, the automated driving ECU 61B is a system that performs automated driving control of the vehicle D of the user R along the route to the destination.

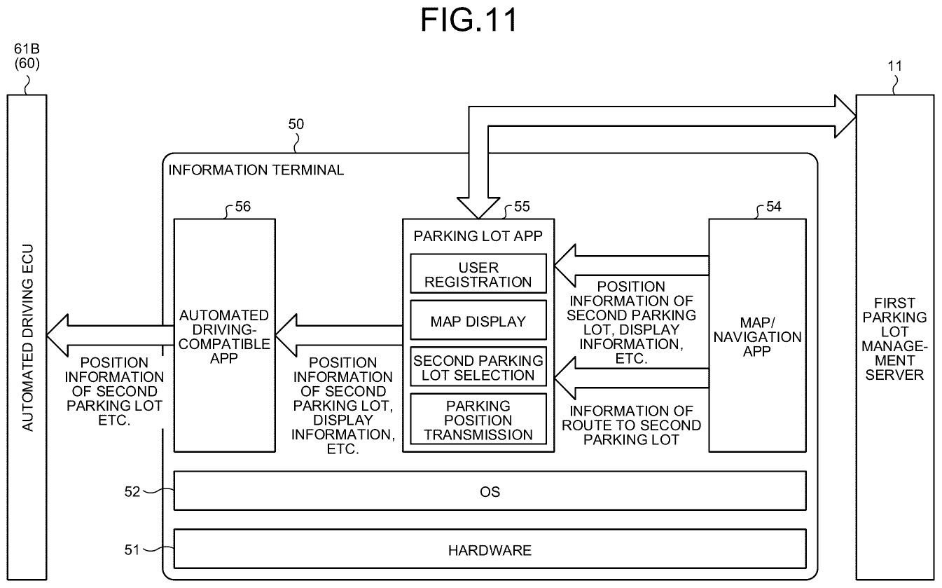

FIG. 11 is a schematic diagram of an example of a cooperative configuration of the automated driving ECU 61B of the vehicle D, an information terminal 50, and a first parking lot management server 11.

The information terminal 50 includes hardware 51, an operating system (OS) 52, and an automated driving-compatible app 56, a map/navigation app 54, and a parking lot app 55, which are apps.

The hardware 51 is various types of hardware provided in the information terminal 50. The automated driving-compatible app 56, the map/navigation app 54, and the parking lot app 55, which are apps, are application programs.

The parking lot app 55 and the map/navigation app 54 are similar to those of the second embodiment.

The automated driving-compatible app 56 is an application that communicates with the automated driving ECU 61B via Bluetooth or the like and can set a destination from the information terminal 50. In the present embodiment, the automated driving-compatible app 56 has a function of transmitting the position information of the second parking lot P2 or the like received from the parking lot app 55 to the automated driving ECU 61B.

Next, an example of a flow of information provision processing in cooperation with the automated driving ECU 61B of the vehicle D in the parking lot management system 1 of the present embodiment will be described.

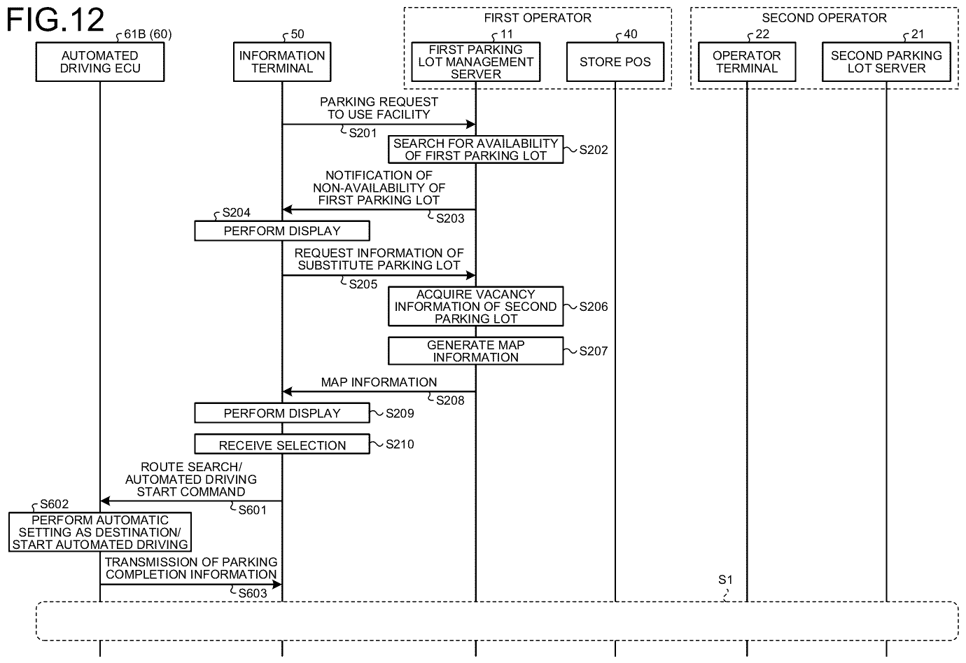

FIG. 12 is a sequence diagram illustrating an example of a flow of information provision processing in cooperation with the automated driving ECU 61B of the vehicle D.

The information terminal 50 and the first parking lot management server 11 execute processing of Steps S201 to S210. The processing of Steps S201 to S210 is similar to that of the first embodiment (see also FIG. 5). That is, a processing unit 12C of the first parking lot management server 11 that has received a parking request to a use facility F from the information terminal 50 searches for the availability of a first parking lot P1 (Steps S201 and S202). Then, the processing unit 12C of the first parking lot management server 11 notifies the information terminal 50 of information indicating non-availability in the first parking lot P1 to display the information on the information terminal 50 (Steps S203 and S204).

Upon acquiring request information inquiring about a substitute parking lot of the first parking lot P1 from the information terminal 50 (Step S205), the processing unit 12C of the first parking lot management server 11 acquires vacancy information indicating the availability of the second parking lot P2 at the time point when the request information is acquired (Step S206). Then, the processing unit 12C of the first parking lot management server 11 generates map information 72 indicating the second parking lot P2 having a vacancy based on the vacancy information acquired in Step S206 (Step S207). Then, the processing unit 12C of the first parking lot management server 11 transmits the map information 72 generated in Step S207 to the information terminal 50 that is the transmission source of the request information acquired in Step S205 to display the map information 72 on the information terminal 50 (Step S208).

A processing unit 50C of the information terminal 50 that has received the map information 72 displays the received map information 72 on a UI unit 50D (Step S209). Then, the processing unit 50C of the information terminal 50 receives selection of the position information of the second parking lot P2 where the user R wants to park among a plurality of second parking lots P2 displayed on the map information 72 (Step S210).

In the present embodiment, the position information of the second parking lot P2 selected from the map information 72 in the information terminal 50 is used to be output to the automated driving ECU 61B associated with the information terminal 50 to cause the vehicle D of the user R to perform automated driving control along the route to the second parking lot P2 indicated by the position information. The automated driving ECU 61B is an example of an automated driving control device.

In detail, the processing unit 50C of the information terminal 50 transmits, to the automated driving ECU 61B, a route search/automated driving start command in which the position information of the second parking lot P2 the selection of which has been received in Step S210 is set as the destination (Step S601).

The automated driving ECU 61B that has received the route search/automated driving start command from the information terminal 50 automatically sets the position information of the second parking lot P2 indicated by the route search/automated driving start command as a destination, and starts automated driving control of the vehicle D along the route to the second parking lot P2 indicated by the destination (Step S602).

Then, when the vehicle D arrives at the second parking lot P2, which is the set destination, the automated driving ECU 61B transmits, to the information terminal 50, parking completion information indicating that the vehicle has been parked in the second parking lot P2 indicated by the position information received in Step S601 (Step S603). The parking completion information includes GPS position information indicating the parking position of the vehicle D, parking time, a parking section number, and the like.

Then, similarly to the first embodiment, the parking lot management system 1 executes the processing of Step S1 (see also FIG. 5), which is the processing of Steps S213 to S226, and ends this sequence.

Next, an example of a flow of information processing executed by the information terminal 50 of the present embodiment will be described.

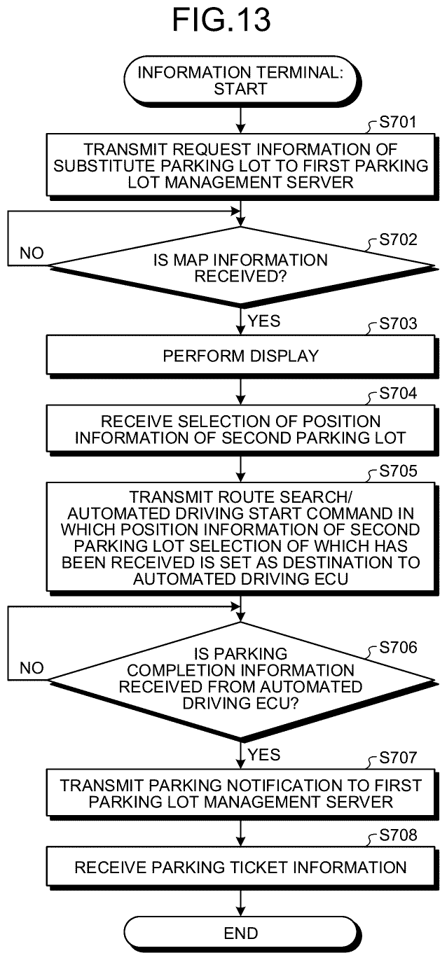

FIG. 13 is a flowchart of an example of a flow of information processing executed in the information terminal 50 of the present embodiment.

The processing unit 50C of the information terminal 50 transmits the request information of the substitute parking lot to the first parking lot management server 11 (Step S701). The processing unit 50C repeats a negative determination (Step S702: No) until the map information 72 is received from the first parking lot management server 11 (Step S702: Yes). Upon receiving the map information 72 from the first parking lot management server 11 (Step S702: Yes), the processing unit 50C displays the received map information 72 on the UI unit 50D (Step S703). Therefore, for example, the map information 72 illustrated in FIG. 6B is displayed on the UI unit 50D of the information terminal 50.

The processing unit 50C of the information terminal 50 receives selection of the position information of the second parking lot P2 where the user R wants to park among the plurality of second parking lots P2 displayed on the map information 72 (Step S704).

The processing unit 50C of the information terminal 50 transmits, to the automated driving ECU 61B, a route search/automated driving start command in which the position information of the second parking lot P2 the selection of which has been received in Step S704 is set as the destination (Step S705). Therefore, the position information of the second parking lot P2 selected from the map information 72 in the information terminal 50 is used to be output to the automated driving ECU 61B associated with the information terminal 50 to cause the vehicle D of the user R to perform automated driving control along the route to the second parking lot P2 indicated by the position information.

Next, the processing unit 50C of the information terminal 50 determines whether parking completion information including the GPS position information indicating the parking position of the vehicle D, the parking time, the parking section number, and the like has been received from the automated driving ECU 61B (Step S706). The processing unit 50C repeats a negative determination (Step S706: No) until an affirmative determination is made in Step S706 (Step S706: Yes). When an affirmative determination is made in Step S706 (Step S706: Yes), the processing proceeds to Step S707.

In Step S707, the processing unit 50C of the information terminal 50 transmits, to the first parking lot management server 11, a parking notification including such as the GPS position information of the vehicle D, the parking time, and the parking section number included in the parking completion information received in Step S706, and the account information of the user R stored in the information terminal 50 (Step S707). Then, the processing unit 50C of the information terminal 50 receives the parking ticket information from the first parking lot management server 11 (Step S708). Then, this routine is ended.

In addition, the information terminal 50 of the present embodiment executes information processing after reception of parking ticket information by performing processing similar to that of the second embodiment described with reference to FIG. 10B.

As described above, in the information provision method of the present embodiment, the position information of the second parking lot P2 is selected from the map information 72 in the information terminal 50, and in the information terminal 50, the position information of the second parking lot P2 is used to be output to the automated driving ECU 61B associated with the information terminal 50 to cause the vehicle D of the user R to perform automated driving control along the route to the second parking lot P2 indicated by the position information.

Therefore, the information provision method of the present embodiment can improve the convenience of the user R by the cooperation with the automated driving ECU 61B in addition to the effects of the first embodiment.

Next, a hardware configuration of the processing unit described in the above embodiments will be described.

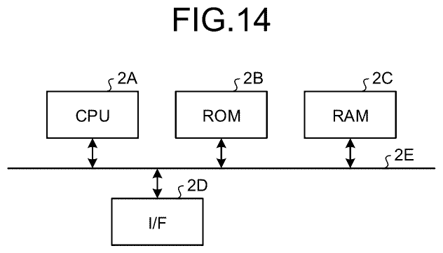

FIG. 14 is a block diagram illustrating a hardware configuration example of the processing unit described in the above embodiments.

The processing unit described in the above embodiments includes a control device such as a central processing unit (CPU) 2A, a storage device such as read only memory (ROM) 2B and random access memory (RAN) 2C, an I/F 2D that is connected to a network and performs communication, and a bus 2E that connects the units.

The program executed by the processing unit described in the above embodiments is provided by being incorporated in the ROM 2B or the like in advance.

The program executed by the processing unit described in the above embodiments may be configured to be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Further, the program executed by the processing unit described in the above embodiments may be configured to be stored on a computer connected to a network such as the Internet and provided by being downloaded via the network. In addition, the program executed by the processing unit described in the above embodiments may be configured to be provided or distributed via a network such as the Internet.

The program executed by the processing unit described in the above embodiments can cause a computer to function as the processing unit described in the above embodiments. In this computer, the CPU 2A can read the program from a computer-readable storage medium onto a main storage device and execute the program.

With the information provision method and the parking lot management system according to the present disclosure, it is possible to alleviate a traffic jam in the vicinity of a use facility during congestion.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information provision method in a first parking lot management system that communicates with an information terminal of a user and manages availability of a first parking lot provided in a use facility, the method comprising:
acquiring, from the information terminal of the user, request information inquiring about a substitute parking lot of the first parking lot;
acquiring, from a second parking lot management system that manages availability of a second parking lot managed by a second operator different from a first operator of the use facility and existing outside an area of the use facility, vacancy information indicating availability of the second parking lot at a time point when the request information is acquired;
generating map information indicating the second parking lot having a vacancy based on the vacancy information, the map information including a message indicating that a second incentive for encouraging the user to use the second parking lot is larger than a first incentive for encouraging the user to use the first parking lot of the use facility; and
transmitting the map information to the information terminal to display the map information on the information terminal.

2. The information provision method according to claim 1, further comprising:
when a notification indicating that a vehicle of the user is parked in the second parking lot indicated in the map information is acquired from the information terminal of the user, transmitting parking ticket information indicating a parking ticket of the second parking lot available in the use facility to the information terminal of the user.

3. The information provision method according to claim 1, wherein
in the information terminal, position information of the second parking lot is selected from the map information, and
in the information terminal, the position information of the second parking lot is used to be output as a destination to a car navigation system of the user associated with the information terminal.

4. The information provision method according to claim 1, wherein
in the information terminal, position information of the second parking lot is selected from the map information, and
in the information terminal, the position information of the second parking lot is used to be output to an automated driving control device associated with the information terminal to cause a vehicle of the user to perform automated driving control along a route to the second parking lot indicated by the position information.

5. The information provision method according to claim 3, wherein
the position information of the second parking lot includes information indicating latitude and longitude of a position of the second parking lot.

6. The information provision method according to claim 4, wherein
the position information of the second parking lot includes information indicating latitude and longitude of a position of the second parking lot.

7. The information provision method according to claim 1, wherein
the use facility includes a commercial facility.

8. The information provision method according to claim 1, wherein
the use facility includes a medical facility.

9. An information provision method in a first parking lot management system that communicates with an information terminal of a user and manages availability of a first parking lot provided in a use facility, the method comprising:
acquiring, from the information terminal of the user, request information inquiring about a substitute parking lot of the first parking lot;
acquiring, from a second parking lot management system that manages availability of a second parking lot managed by a second operator different from a first operator of the use facility and existing outside an area of the use facility, vacancy information indicating availability of the second parking lot at a time point when the request information is acquired;
generating map information indicating the second parking lot having a vacancy based on the vacancy information, the map information including a message indicating that a second free parking duration when the second parking lot is used is longer than a first free parking duration when the first parking lot of the use facility is used; and
transmitting the map information to the information terminal to display the map information on the information terminal.

10. An information provision method in a first parking lot management system that communicates with an information terminal of a user and manages availability of a first parking lot provided in a use facility, the method comprising:
acquiring, from the information terminal of the user, request information inquiring about a substitute parking lot of the first parking lot;
acquiring, from a second parking lot management system that manages availability of a second parking lot managed by a second operator different from a first operator of the use facility and existing outside an area of the use facility, vacancy information indicating availability of the second parking lot at a time point when the request information is acquired;
generating map information indicating the second parking lot having a vacancy based on the vacancy information, the map information including a message indicating that a second use amount in the use facility in which a parking fee is free when the user uses the second parking lot is smaller than a first use amount in the use facility in which the parking fee is free when the user uses the first parking lot of the use facility; and
transmitting the map information to the information terminal to display the map information on the information terminal.

11. An information provision method in a first parking lot management system that communicates with an information terminal of a user and manages availability of a first parking lot provided in a use facility, the method comprising:
acquiring, from the information terminal of the user, request information inquiring about a substitute parking lot of the first parking lot;
acquiring, from a second parking lot management system that manages availability of a second parking lot managed by a second operator different from a first operator of the use facility and existing outside an area of the use facility, vacancy information indicating availability of the second parking lot at a time point when the request information is acquired;
generating map information indicating the second parking lot having a vacancy based on the vacancy information, the map information including a message indicating that a second incentive for encouraging the user to use the second parking lot is larger than a first incentive for encouraging the user to use the first parking lot of the use facility;
transmitting the map information to the information terminal to display the map information on the information terminal; and
transmitting, when a notification indicating that a vehicle of the user is parked in the second parking lot indicated in the map information is acquired from the information terminal of the user, parking ticket information indicating a parking ticket of the second parking lot available in the use facility to the information terminal of the user.

12. A parking lot management system that communicates with an information terminal of a user and manages availability of a first parking lot provided in a use facility, the system comprising:
a memory; and
a processor coupled to the memory and configured to:
acquire, from the information terminal of the user, request information inquiring about a substitute parking lot of the first parking lot;
acquire, from a second parking lot management system that manages availability of a second parking lot managed by a second operator different from a first operator of the use facility and existing outside an area of the use facility, vacancy information indicating availability of the second parking lot at a time point when the request information is acquired;
generate map information indicating the second parking lot having a vacancy based on the vacancy information, the map information including a message indicating that a second incentive for encouraging the user to use the second parking lot is larger than a first incentive for encouraging the user to use the first parking lot of the use facility; and
transmit the map information to the information terminal to display the map information on the information terminal.

13. The parking lot management system according to claim 12, further comprising:
when a notification indicating that a vehicle of the user is parked in the second parking lot indicated in the map information is acquired from the information terminal of the user, the processor is configured to transmit parking ticket information indicating a parking ticket of the second parking lot available in the use facility to the information terminal of the user.

14. The parking lot management system according to claim 12, wherein
in the information terminal, position information of the second parking lot is selected from the map information, and
in the information terminal, the position information of the second parking lot is used to be output as a destination to a car navigation system of the user associated with the information terminal.

15. The parking lot management system according to claim 12, wherein
in the information terminal, position information of the second parking lot is selected from the map information, and
in the information terminal, the position information of the second parking lot is used to be output to an automated driving control device associated with the information terminal to cause a vehicle of the user to perform automated driving control along a route to the second parking lot indicated by the position information.

16. The parking lot management system according to claim 14, wherein
the position information of the second parking lot includes information indicating latitude and longitude of a position of the second parking lot.

17. The parking lot management system according to claim 15, wherein
the position information of the second parking lot includes information indicating latitude and longitude of a position of the second parking lot.

18. The parking lot management system according to claim 12, wherein
the use facility includes a commercial facility.

19. The parking lot management system according to claim 12, wherein
the use facility includes a medical facility.
